(19) United States
(12) Patent Application Publication
(10) Pub. No.: US 2026/0016685 A1
(43) Pub. Date: Jan. 15, 2026

(54) NON-SEQUENTIAL SCANNING OF SUBSTANCES

(71) Applicant: Carterra, Inc., Salt Lake City, UT (US)

(72) Inventors: Andrew HATCH, West Jordan, UT (US); Adam BOYLE, Salt Lake City, UT (US); John VISSER, West Bountiful, UT (US); James SMITH, Bountiful, UT (US); Josh ECKMAN, Woods Cross, UT (US)

(21) Appl. No.: 19/257,586

(22) Filed: Jul. 2, 2025

Related U.S. Application Data
(60) Provisional application No. 63/668,059, filed on Jul. 5, 2024.

(51) Int. Cl. G02B 26/10

(52) U.S. Cl. CPC G02B 26/108

(57) ABSTRACT

An optical sensing system can include illuminator optics, including light source, a lens assembly, and an optical deflector capable of modifying an angle of light energy via angle skipping. The illuminator optics can be adapted or adaptable to optically scan non-sequential angle positions of a substance or substances carried by a scannable substrate including at a region of interest (ROI), a reference region of scannable substrate, or both. The system can also include imager optics including a detector to receive the light energy after interaction with the ROI, the reference region, or both associated with the scannable substrate. Other types of scanning are also disclosed that do not rely on angular light scanning or optics.

The present application claims the benefit of U.S. Provisional Patent Application No. 63/668,059, filed on Jul. 5, 2024, the entirety of which is incorporated herein by reference.

### BACKGROUND

There are many sensing technologies that can be used for scanning, sensing, detecting, characterizing, and/or otherwise interacting with biological or chemical substances. These sensing technologies can incorporate a probe signal, a sample that interacts with the probe signal, and a detector which measures that interaction, for example. Examples of various types of sensing technologies include systems and devices for sensing Surface Plasmon Resonance (SPR), Surface Plasmon Resonance Imaging (SPRi), Plasmon-Waveguide Resonance (PWR), Grating-Coupled Interferometry (GCI), Biolayer Interferometry (BLI), Waveguide Interferometry (WI), Quartz Crystal Microbalance (QCM), Fiber-optic Surface Plasmon Resonance, FTIR reflectance Spectroscopy, Raman Spectroscopy, X-ray Fluorescence, Scanning Electron-Energy Dispersive X-ray Analysis, etc. Some of these methods change properties or aspects of the probe signal during each measurement. Inherent in changing the signal in real systems is that the detected signal varies due to noise in the system. Scanning in such systems can refer to moving the probing signal to different regions of the sample or it might refer to changing the properties or aspects of the probing signal while it is fixed on one region of the sample.

As an example, SPR occurs under conditions where electrons of a conductive substrate, e.g., thin metal film, metal coupon, grating, semitransparent metal film, etc., become excited by light, e.g., plane-polarized light (the probe signal), directed thereto at a given angle of incidence, which can be sensed as reflected light using a detector, such as a light detection chip, a camera, or other light detection technology. The conductive substrate may be optically associated with an internal reflection prism with a high refractive index. Thus, an SPR sensing device can be in the form of an optical sensing system that uses a light source to direct light energy toward the conductive substrate at an angle of incidence to optically couple the directed light with the conductive substrate. The conductive substrate can be positioned on or within a scannable substrate, e.g., an application surface, where chemistries (the sample) and changes thereto can be detected. If the light source has a constant wavelength, the angle of incidence that triggers SPR to occur at the application surface is related to the refractive index of the material, and thus, small changes in the refractive index will cause SPR to not be observed, making SPR detection a good approach to detecting particular substances, e.g., analytes, applied to the application surface. In further detail, at a certain critical angle of incidence (θ), the incident light photons can be absorbed in the conductive surface and the energy can then be transferred to the electrons and then to surface plasmons. The total internal reflection intensity through the internal reflection prism and the reflected light intensity recorded at the detector provides a manner of quantitatively recording the adsorption of the substances (if any) on the application surface. As surface detection using this method is very sensitive, changes in wavelength, light intensity, angle of directed light, temperature, bulk drift, optical alignment, and signal noise can complicate the generation of reliable data in some instances.

### BRIEF DESCRIPTION OF THE DRAWINGS

FIG. 1 illustrates perspective views of an example microfluidic flow cell array including a fluid directing body and an application tip joinable or joined therewith in accordance with the present disclosure;

FIG. 2 illustrates a schematic view of an example substance spotter system including mechanical architecture, a microfluidic flow cell array, and a sensor chip mounted on an optical prism in accordance with the present disclosure;

FIG. 3 illustrates a perspective view of an example optical sensing system optically interacting with, and a sensor chip mounted on, an optical prism in accordance with the present disclosure;

FIG. 4 illustrates example resonance (or other types of) curves that can be created by capturing a different number of frames per scan in accordance with the present disclosure;

FIG. 5 illustrates a traditional resonance curve obtained by SPR sequential scanning 66 frames across an angular range of about 3° in accordance with the present disclosure;

FIG. 6A illustrates example reflectance noise scaled at 1,000-fold (10⁻³ reflectance) that can occur, with this example scanning 200 frames repeated across 16 scans in accordance with the present disclosure;

FIG. 6B illustrates the data collected in FIG. 6A with the 16 scans averaged into a composite average scan resulting in improved curve fitting precision in accordance with the present disclosure;

FIG. 7 illustrates example SPR resonance curves scanned with 25, 50, 100, or 200 frames per scan, each resulting in different sensorgram noise levels (based calculated resonance unit (RU) over time) in accordance with the present disclosure;

FIG. 8 illustrates example scan resolutions at 25 frames per scan showing that sensorgram noise can be reduced compared to a single scan (1×) when averaging multiple scans with increased noise reduction as the number of scans increases, e.g., 2×, 4×, 8×, and 16× in accordance with the present disclosure;

FIG. 9 illustrates an example graph depicting various types of signal variance sources that can contribute to inaccurate sensorgram graphs in accordance with the present disclosure;

FIG. 10 illustrates an example SPR resonance curve graph including both a reference resonance curve and a region of interest (ROI) resonance curve in accordance with the present disclosure;

FIG. 11 illustrates three (3) examples superimposed sensorgram curves generated from sequential scanning, including curves related to a region of interest (ROI), a reference region, and an ROI-reference curve in accordance with the present disclosure;

FIG. 12 illustrates an example of how referenced noise is typically greater with fewer sequential scans at a lower number of frames captured scan and is typically greater as the number of scans and frames per scan is increased in accordance with the present disclosure;

FIG. 13 is an example 2D graph illustrating RMS noise reduction is generally reduced by increasing the number of sequential scans that are averaged in accordance with the present disclosure;

FIG. 14 illustrates the same data illustrated in FIG. 13 with the data instead shown as 3D graphs represented at different 4 different viewpoints in accordance with the present disclosure;

FIG. 15 illustrates an example resonance curve graph depicting representative surface plasmon resonance (SPR) dip curve variations in accordance with the present disclosure;

FIG. 16 illustrates examples of three different types of noise that can occur when collecting SPR resonance data using one or more of the sensing technologies, e.g., SPR, SPRi, etc., in accordance with the present disclosure;

FIG. 17 illustrates an example SPR resonance curve graph with a time domain noise overlay illustrating low frequency noise (LFN), middle frequency noise (MFN), and high frequency noise (HFN) in accordance with the present disclosure;

FIG. 18 illustrates an example approach for generating SPR resonance curves by sequential scanning from left to right (or right to left) in accordance with the present disclosure;

FIG. 19 illustrates example reference resonance curves and ROI resonance curves superimposed over one another in accordance with the present disclosure;

FIG. 20 illustrates a pair of example graphs depicting periodic noise and a corresponding RU shift after sequential scanning in accordance with the present disclosure;

FIG. 21 illustrates a pair of example graphs depicting random (Gaussian) noise and a corresponding RU shift after sequential scanning in accordance with the present disclosure;

FIG. 22 illustrates a pair of example graphs depicting intermittent noise and a corresponding RU shift after sequential scanning in accordance with the present disclosure;

FIGS. 23-24 illustrate an example approach for generating an SPR curve by non-sequential scanning, e.g., interlace scanning as shown, in accordance with the present disclosure;

FIG. 25A illustrates an SPR resonance curve with 66 sequentially scanned data points captured via a single pass in accordance with the present disclosure;

FIG. 25B illustrates an SPR resonance curve capture with 66 non-sequential scanned data points captured via 16 passes in accordance with the present disclosure;

FIGS. 26A-26D illustrate example alternative ways of collecting non-sequential resonance curve data, including using (i) different numbers of passes, e.g. 10 passes, 5 passes, or 1 pass, and/or (ii) different types of non-sequential scanning, e.g., interlace scanning or random scanning, in accordance with the present disclosure;

FIG. 27 illustrates a pair of example graphs depicting periodic noise and a corresponding RU shift after interlace scanning in accordance with the present disclosure;

FIG. 28 illustrates a pair of example graphs depicting random (Gaussian) noise and a corresponding RU shift after interlace scanning in accordance with the present disclosure;

FIG. 29 illustrates a pair of example graphs depicting intermittent noise and a corresponding RU shift after interlace scanning in accordance with the present disclosure;

FIG. 30 illustrates three (3) examples superimposed sensorgram curves generated from non-sequential scanning, e.g., interlace scanning, including curves related to a region of interest (ROI), a reference region, and an ROI-reference curve in accordance with the present disclosure;

FIG. 31 illustrates an example of how referenced noise is also typically greater with fewer non-sequential scans, e.g., interlace scans, at a lower number of data points, e.g., frames, captured and is typically greater as the number of scans and frames per scan is increased in accordance with the present disclosure;

FIG. 32 is an example 2D graph illustrating RMS noise reduction is generally reduced by increasing the number of scans, with examples for sequential scanning and interlace scanning providing data ranging from 25-500 data points, e.g., frames, per scan and then averaged in accordance with the present disclosure;

FIGS. 33A-33D illustrate the same data illustrated in FIG. 32 with the data instead shown as 3D graphs represented at different 4 different viewpoints for both sequential scanning and interlace scanning in accordance with the present disclosure;

FIG. 34 illustrates a pair of example graphs comparing the periodic noise RU shift obtained by sequential scanning compared to non-sequential (interlace) scanning in accordance with the present disclosure;

FIG. 35 illustrates a pair of example graphs comparing the random (Gaussian) noise RU shift obtained by sequential scanning compared to non-sequential (interlace) scanning in accordance with the present disclosure;

FIG. 36 illustrates a pair of example graphs comparing the intermittent noise RU shift obtained by sequential scanning compared to non-sequential (interlace) scanning in accordance with the present disclosure;

FIG. 37 illustrates an example graph depicting the root mean square (RMS) noise with at least four frequencies exhibiting amplitudes peaking between about 3 RU and about 5.5 RU after sequential scanning in accordance with the present disclosure;

FIG. 38 illustrates an example graph depicting the root mean square (RMS) noise with all frequencies having amplitudes peaking between about 1.5 RU and about 2.2 RU after non-sequential (interlace) scanning in accordance with the present disclosure;

FIG. 39 illustrates an example graph depicting the RMS noise (RU) that can be introduced as it relates to frequency used, with both a sequential scanning comparative and multiple non-sequential (interlace) scanning in accordance with the present disclosure;

FIG. 40 illustrates an alternative example graph depicting the RMS noise (RU) that can be introduced as it relates to frequency when captured at a different signal level (representative of increasing light intensity or camera capture time) with both a sequential scanning comparative and multiple non-sequential (interlace) scanning in accordance with the present disclosure; and

FIG. 41 illustrates an example graph depicting RU referenced RMS noise vs. frequency with both a sequential scanning comparative and multiple non-sequential (interlace) scanning in accordance with the present disclosure.

### DETAILED DESCRIPTION

In accordance with examples herein, the present disclosure provides optical sensing systems and methods for non-sequential scanning of substances, e.g., SPR interlace resonance scanning or some other type of interlace scanning, which are suitable for high throughput substance observations, evaluations, characterizations, etc. with a reduced noise profile. By decoupling the optical scanning of a substance(s) associate with a scannable substrate from more traditional sequential time-dependent scanning (or sequential sweeping), a reduced noise profile of the substance at a region of interest, or ROI, which is referenced against a reference region can be realized. For example, both raw signal RMS noise as well as the typical increase in referenced noise can be reduced. To illustrate by a more specific example, often RMS noise from two raw signals at 1 RMS noise may increase about 80% to about 1.8 RMS noise. On the other hand, with interlace scanning, the RMS noise may only increase by about 20% to about 1.2 RMS noise. This suggests a two factor improvement, namely lower raw noise and better noise correlation with respect to time. Furthermore, in complex systems, it is difficult to find the correct signal capture combination that avoids resonant and harmonic frequencies with all of the motors, pumps, valves, compressors, fans, power supplies, control boards, and so forth. Given the constraints of scan resolution in general, it can be difficult to shift away from a particularly problematic frequency without compromising performance.

In accordance with this, an optical sensing system can include illuminator optics and imager optics. The illuminator optics can include a light source, a lens assembly, and an optical deflector capable of modifying an angle of light energy via angle skipping. Another implementation could be to use a tunable optical filter to modify or scan the wavelength of incident light incumbent on the SPR surface. The illuminator optics can be adapted or adaptable to optically scan non-sequential angle positions of a substance(s) associated with a scannable substrate including at an ROI and at a reference region of the scannable substrate. The non-sequential can be in the form of interlace scanning, or can be some other non-sequential pattern, such as random, varied spacing, etc. In some examples, this operation variability can be carried out using an optical deflector, such as an acousto-optical deflector (AOD), an acousto-optical modulator (AOM), an electro-optical deflector (EOD), or the like. The imager optics can include a detector to receive the light energy after electromagnetic interaction with the ROI, the reference region, or both along the scannable substrate. In examples herein, the non-sequential angle scan, e.g., interlace scan, random scan, etc., can then be recomposed or reassembled in a manner similar to a traditional curve to generate sensorgrams showing more sensitivity due to a reduced noise profile. The process of scanning angular position in a non-sequential pattern allows decoupling of the angular domain and the time domain into independently configurable sequences. The time dependent noise can then be re-distributed throughout the angular scan in a non-sequential pattern to reduce aliasing effects or biased shifts in specific angular regions of the scan.

In another example, a method of optical scanning a substance(s) associate with a scannable substrate can include non-sequentially scanning, e.g., interlace scanning, random scanning, etc., a scannable substrate having a substance spot at a region of interest deposited thereon, and a reference region. Non-sequentially scanning can include capturing multiple discontinuous data points, e.g., frames, in sequential time at discontinuous angle positions. The method can further include reassembling the multiple frames in sequential angle position order to generate an ROI curve and a reference curve.

In another example, a flow cell optical resonance scanning system can include a sensor chip including an application surface adapted to receive a plurality of substance spots at multiple regions of interest (ROI) while leaving multiple reference regions devoid of substance spots for referencing, and an optical interface surface positioned facing a direction opposite the application surface. The system can further include a microfluidic flow cell array, illuminator optics, and imager optics. The microfluidic flow cell array can include multiple flow cells to deposit multiple substance spots on the application surface. The illuminator optics can include a light source, a lens assembly, and an optical deflector capable of modifying an angle of light energy via angle skipping. The illuminator optics can be adapted or adaptable to direct light energy toward the optical interface surface at non-sequential resonance angle positions to generate resonance along the application surface. The imager optics can include a detector to receive the light energy after reflection from the optical interface and electromagnetic interaction with the application surface at the ROI and the reference region.

In another example, a method of preparing and optical resonance scanning an application surface can include depositing multiple substance spots on an application surface (or other scannable substrate), non-sequentially scanning, e.g., interlace scanning, varied spacing scanning, random scanning, etc., the substance spots on the application surface, and reassembling the multiple discontinuous data points, e.g., frames, in sequential resonance angle position order to generate an ROI resonance curve and a reference resonance curve. The application surface can be incorporated into a sensor chip, and application of the substance spots can form multiple regions of interest on the application surface while leaving at least one reference region without application of a substance spot. The depositing can be carried out by a microfluidic flow cell array having multiple flow cells. The sensor chip can also include an optical interface surface positioned facing a direction opposite the application surface. Non-sequentially scanning can occur by directing light energy toward the optical interface to generate optically detectable resonances at the regions of interest and optically detectable noise resonance at the at least one reference region. Non-sequentially scanning can include capturing multiple frames in sequential time at discontinuous resonance angle positions.

It is noted that when discussing the optical sensing systems and/or methods of the present disclosure, these discussions are considered applicable to other examples whether or not they are explicitly discussed in the context of that example unless expressly indicated otherwise. Thus, for example, when discussing a certain type of fluid or deposition substance, or material of construction, or the like, in the context of any of the devices, systems, and/or methods herein, such disclosure is also relevant to and directly supported in context of the other example devices, systems, and methods, and vice versa. Furthermore, for simplicity and illustrative purposes, numerous specific details are set forth in order to provide a thorough understanding of the present disclosure. It will be readily apparent however, that the present disclosure can be practiced without limitation to some of these specific details. In other instances, certain devices, systems, methods, materials, and structures have not been described in detail so as not to obscure the present disclosure.

When capturing data generally using optical sensing technology, such as with surface plasmon resonance (SPR) technology or some other type of optical resonance scanning, interferometry scanning, or other scanning technologies, it can be beneficial to sense a “region of interest” (ROI) where a substance has been associated with a scannable substrate, e.g., application surface, a small volume container, etc., in comparison to other regions where no substance has been applied, which is referred to herein as “reference” or “reference region.” In this way, some of the noise that is introduced by the optical equipment and other factors can be subtracted out (referenced out) to improve the fidelity of the data collected. Notably, there are several different types of “noise” that can be introduced by SPR devices/systems (and other similar optical measurements) that can be problematic when trying to obtain accurate data values for generating curves, e.g., resonance curves or other curves generated using other technologies. Depending on the time-scale of these noise sources, the same noise may not exist in both the reference region and ROI, which may reduce the effectiveness of the elimination of noise when subtracting the reference data from the ROI data. This noise may be attributable to bulk shifts in refractive index when a chemical composition is changed, thermal drift, etc. Noise at other time-scales might vary between the time the reference region is scanned and the ROI is scanned, and the noise in such circumstances may not reference out as well. Examples of such noise include periodic noise at frequencies relevant to the scan speed, random (Gaussian) noise, and intermittent noise (spike noise) or shock events. Thus, two types of noise variation may occur, namely noise correlated or caused by certain physical attributes while carrying out the experiment and/or noise related to random, non-correlated change which can happen at a different time-scale or are not discrete shifts. Correlated noise can include thermal drift, gas solubility in a solution, chemical composition differences, index of refraction differences, fluid control variation, etc. These are often correlated across all ROIs and reference spots and can persist for relatively long time period scales allowing data collection for multiple data scans so referencing is good at eliminating noise from these sources. Non-correlated noise can include detector system noise such as electrical noise, illumination noise, vibrations, shock, etc. Non-correlated noise does not reference out as well because it varies on a shorter time-scale, many times shorter than the sampling time e.g., the microsecond (usec) to several milliseconds (msec) range. Because of this, the reference and ROI data collected will often not reflect the same noise in the data and subtraction of the reference data from the ROI data does not eliminate the noise. Periodic noise, Gaussian (random) noise, and intermittent (spike) noise tend to fall in this category of non-correlated noise.

When sensing a chemistry reaction of a substance associated with a scannable substrate, such as an application surface using SPR or some other resonance sensing technology for example, the demands for capture frequency can be driven by the rate of change in the reaction. In general, it can be beneficial to catch the fastest expected change likely to occur in a reaction that is being sensed. Furthermore, there can also be hardware and software limitations that make it a challenge to obtain the highest quality data at that capture rate. For example, in trying to target 2 Hz data resolution with about a 1 kHz frame rate capture, up to about 500 frames of captured data may be generated, for example.

In further detail, a mathematical curve is often fit to a subset of data taken from a region of interest (ROI). In an angular scanning SPR system (incidence angle and/or polarization angle), this subset may only represent a portion of a typically larger dynamic range (or signal range), e.g., angular range, range of wavelengths, etc. For example, when optically sensing the ROI associated with a scannable substrate, the ROI response may have a typical span of about 0.5° within an angular range from 0° to about 3°. In achieving high fidelity, competing principles to be balanced may include high resolution SPR scans for increased linearity, precision, and accuracy of a single scan, versus high signal averaging for improved precision and resolution from one timepoint to the next. As an example, achieving high resolution for increased (even maximized) linearity, precision and accuracy may include capturing at least about 20 data points per SPR curve (within the 0.5° span) and about 120 or more data points to cover the remainder of the full angular range of the scanning sweep (sequential scanning). A higher number of data points captured per sweep typically improves the mathematical curve fit. On the other hand, high signal averaging for maximum precision and resolution (lowest noise) is also a goal, trying to keep the signal noise as low as possible (limited by design, environment of system, etc.). Often, averaging multiple sequential scanning sweeps can help with averaging out random variation with uncorrelated noise scaling down as √n (correlated noise not typically reduced). Achieving this balance efficiently can be difficult due to camera capture rates, scanning speed of moving parts, system noise introduced as a variable, e.g., periodic noise, random noise (Gaussian noise), and noise spikes (intermittent noise). Random noise is generally uncorrelated, whereas periodic noise and intermittent noise may be correlated. To achieve good results considering these competing principles, it may be desirable to capture about 250 data points per sweep which is averaged over a total of 10 sweeps which would correspond to a 2,500 Hz capture rate. In reality, the capture of about 60 data points per sweep averaged over a total of 8 sweeps for a 496 Hz capture rate are more typical, which results in reduced accuracy, resolution, and precision with increased noise.

As an example, the combination of 60 data points per sweep and averaged over 8 sweeps yields a good compromise for low noise profile and adequate signal resolution with most types of noise. The resonance frequencies of some periodic noise can correlate with the SPR curve shape at those capture-rates, resulting in noise amplification rather than noise dampening. In complex systems, it is difficult to find the correct signal capture combination that avoids resonant and harmonic frequencies with all of the motors, pumps, valves, compressors, fans, power supplies, control boards, and so forth. Given the constraints of the scan resolution, it is difficult to shift away from a particularly problematic frequency without compromising performance.

In accordance with the present disclosure, rather than using a sequential scanning sweep during the data collection phase and trying to remove noise after the data has already been collected), a time-distributed scan of the probe signal by non-sequentially scanning (also referred to in the examples herein as “non-sequential angular scanning”) can occur followed by reassembly of the detected signal to its sequential order, to generate data from the region of interest (ROI) that is cleaner, more accurate, and has considerably less noise, even when the data is captured at lower capture rates. As an example, one type of dynamic range that can be scanned using the interlaced scanning technology described herein includes the use of an angular range, e.g., from 0° to about 2-4°, from 0° to about 3°, etc., can be captured using a non-sequential pattern of smaller slices of data within the available angular range, where each slice of data contains a sparse selection of data points out of the full angular range, e.g., each data point steps from about 0.1° to about 2°, from about 0.1° to about 1°, from about 0.1° to about 0.8°, from about 0.1° to about 0.6°, from about 0.2° to about 0.8°, from about 0.3° to about 0.7°, or from about 0.4° to about 0.6°, from about 0.5° to about 1.5°, from about 1° to about 3°, etc. By scanning non-sequentially (randomly or in a pattern), noise that is fluctuating over the time it takes to sweep through one complete scan can be distributed throughout the scan data, which decorrelates the correlated noise. This data can then be recomposed into the appropriate angular sequence giving data across either the entire angular range or portions of the angular range. In some examples, there may be utility in skipping or disregarding regions of the full angular range due to low response so that faster scanning or more focus can be placed on regions of higher response. In addition to decorrelating the time domain noise throughout the interlace scan (post sequential reassembly), the time domain averaging is improved, with higher scan fidelity. As an example, for a scan with 166 frames per second (fps), which can be 16 scans and 10-11 frames per scan that is averaged three (3) times, noise reduction was achievable that was four (4) times lower than when the same equipment was used to collect the same data sequentially. In further detail, non-sequential scanning non-sequentially scanning may include scanning wavelengths to generate data points in sequential time but having non-sequential wavelength values. Thus, there may be instances where the angle of scanning is fixed, but the wavelength is varied in a non-sequential manner. Thus, non-sequential scanning can include collecting data at various positions in a non-incremental, random, or pseudo-random order, such that the positions are not scanned in their natural, angular, or spatial sequence. This can reduce the likelihood that data collected at adjacent time points will be angularly correlated, thereby minimizing the effects of time-dependent variations. As a note, referencing may be applied immediately or later in time relative to when the sensorgram curve is generated, and referencing may be applied at that time, for example.

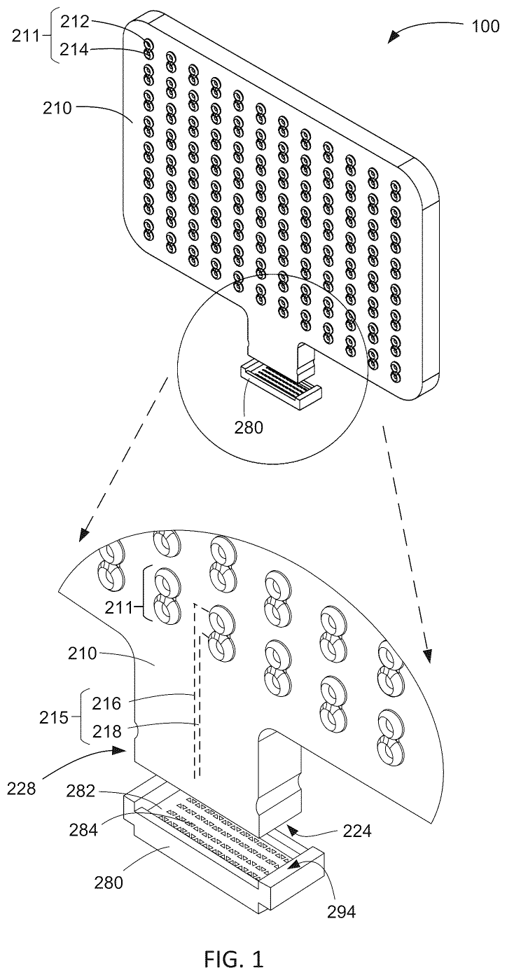

When the scannable substrate is an application surface, for example, equipment that can be used for depositing samples on an application surface and collecting resonance data of various samples thereon is illustrated in FIGS. 1-3. This equipment illustrates example SPR resonance angular scanning equipment, but could be some other type of scanning equipment, such as optical scanning equipment that utilizes resonance, interferometry, or other optical detection systems, e.g., wavelength scanning SPR, surface plasmon resonance imaging (SPRi), plasmon-waveguide resonance (PWR), grating-coupled interferometry (GCI), biolayer interferometry (BLI), waveguide interferometry (WI), or a combination thereof. Thus, when referring to “resonance,” such is the case with SPR, SPRi, PWR, etc., non-sequential resonance curves, resonance angle position, etc., such examples are provided for technologies that utilize resonance scanning. In examples that utilize other types of optical scanning technology, the term “resonance” can be removed from any of the disclosure herein so that the terms are appropriately applicable to these other types optical scanning technologies, e.g., GCI, BLI, WI, etc. It is noted that when referring to “angle” or “angular” as the attribute or property of a signal being scanned, the term “angle” or “angular” can be removed so that terms that are appropriately applicable to other types of scanning technologies may be used, e.g., wavelength, phase, polarization angle, magnetic field etc. Thus, such replacement is applicable herein wherever these terms are present herein when the scanning technology does not include an angular scanning component.

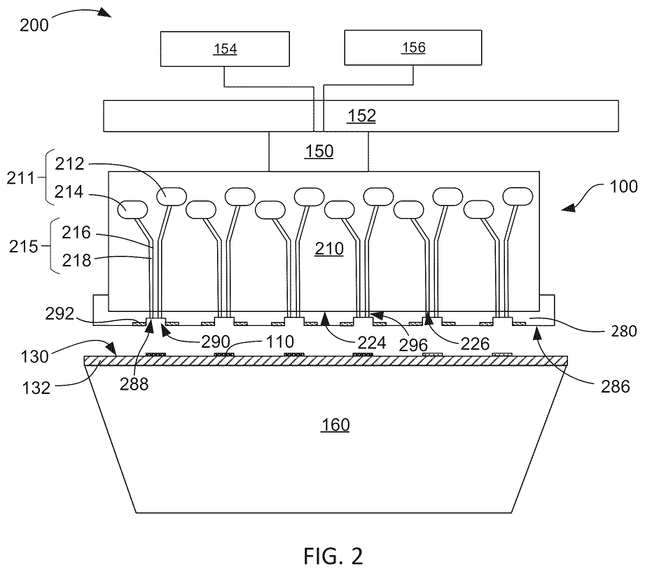

In accordance with this, FIG. 1 illustrates a perspective view of an example microfluidic flow cell array 100 which includes a fluid directing body 210 connectable or connected to an applicator tip 280, and this technology can be particularly suitable for one or more of the optical scanning resonance technologies described herein. These two structures may be modular or may be integrated together as a single unitary part or may be fabricated as a single monolithic part. The fluid directing body in this example includes multiple source fluid openings 211 or fluid ports, which are shown as being grouped in pairs 212 and 214. In this arrangement, individual pairs of fluid ports can be fluidly coupled to a common flow chamber (not shown but illustrated by example in FIG. 2) for fluid ingress and/or egress, for example.

In this example, the applicator tip 280 is shown to include a proximal tip surface 282 defining a plurality of proximal tip openings 284, which in this instance are triangle-shaped, but it is understood that other shapes, e.g., triangular, rectangular, circular, etc., can likewise be used for application of fluid substances onto an application surface (not shown) The proximal tip openings are arranged as a 4×20 array of openings. However, the proximal tip openings and/or flow chamber (not shown, but shown in FIG. 2) can be configured in any of a number of configurations, such as in rows and columns (as shown), shaped patterns, e.g., circles, rectangles, triangles, other polygons, etc., staggered patterns, random patterns, etc. If the microfluidic flow cell array is a modular system, the applicator tip can have a proximal tip coupling feature 294, which in this instance includes a pair of laterally positioned flanges that can be used to pressure fit about a distal end 228 of the fluid directing body 210, thus aligning the distal body openings (shown at 226 in FIG. 2) with the proximal tip openings. For example, the pair of flanges may be formed of a rigid material sufficient to compress a softer material found at the distal end of the fluid directing body. Other types of proximal tip coupling features that may be used include magnets (with corresponding magnets at the distal end of the fluid directing body), tongue or groove connectors, snaps, screws, clamps, pins, loop or hook fasteners, click fasteners, compression fittings, permanent magnets, electromagnets, temporary adhesives, temporary bonding compounds, electrostatic elements, spring locks, slide fasteners, or a combination thereof. In examples where the fluid directing body and the applicator tip are unitary (not-modular), these two structures can be formed as a monolithic part or may be formed separately and joined together more permanently, such as by the use of heat melting, adhesive, or the like.

In further detail, and as shown in FIG. 2, an example schematic of a substance spotter system 200 is shown that includes a microfluidic flow cell array 100. As an initial matter, the microfluidic flow cell array is shown as being present in the context of an example substance spotter system, including a variety of positioning and force sensors, e.g., z-axis positioner 150, xy-axis positioner 152, positioning sensor 154, force sensor 156, etc. In some examples, there may also be a tip positioning sensor 292 positioned as part of the microfluidic flow cell array, which as shown in this example, is present at a distal tip surface 286 of an applicator tip 280. The substance spotter system shown in this specific embodiment also depicts solid optical material 160, which in this example is an optical prism with an application surface 130 optically associated with a sensor chip 132. This arrangement may be particularly useful for surface plasmon resonance (SPR) applications. However, it is noted that other arrangements can be used with the microfluidic flow cell arrays of the present disclosure, including the use of other positioners and/or other application surfaces.

Referring now more specifically to the microfluidic flow cell array 100 shown by way of example in FIG. 2 (which can be similar to that shown in FIG. 1), the microfluidic flow cell array can include a fluid directing body 210 and an applicator tip 280. Other structures may be present, such as an intervening fluid control adapter therebetween, which is not shown in this example. Notably, for clarity these two structures are shown as being connected for operation, but these two structures may be separated in some examples, e.g., modular system. Regarding the fluid directing body, this structure can define a plurality of body microfluidic channels 215. The plurality of body microfluidic channels can include multiple pairs of a first body microfluidic channel 216 and a second body microfluidic channel 218. It is noted that though the FIGS. hereinafter typically show pairs of body microfluidic channels, in some examples, there may be instances where there is no return fluid flow channel or where there are more than a pair of channels servicing a single flow chamber 290. Referring to these two structures separately, e.g., the fluid directing body and the applicator tip, the body microfluidic channels can fluidically connect source fluid openings 211 (pair of source fluid openings shown at 212 and 214) with distal body openings 226 located along a distal body surface 224. The “distal body surface” can be an interface surface of the fluid directing body that interfaces with the applicator tip (or any intervening structures, if present) to connect body microfluidic channels with the applicator tip to form or contribute to the formation of multiple individual flow cells. The body microfluidic channels of the fluid directing body can be directly connected to corresponding applicator tip microfluidic channels. The applicator tip provides the function of application of a substance from a fluid flowing therethrough via its flow chambers, thus leaving substance spots 110 behind on an application surface 130, which in this instance, includes a sensor chip 132 deposited on a solid optical material 160, e.g., optical prism. In some examples, there may not be a sensor chip used, but rather there may be instances where a layer or coating of a material is applied directly to a solid optical material, for example.

In addition to that shown by way of example in FIG. 2, any number of other features or devices may be attached to the substance spotter system 200. A few examples may include pumps, blowers, vacuums, fluid lines, heating/cooling jackets, mounting hardware, and reservoirs such as beakers or microtiter plates. The various flow cells formed by connecting the components of the microfluidic flow cell array 100 may both direct fluid and return fluid from the application surface 130 to different reservoirs or to the same reservoir connected to the source fluid openings 211 of the fluid directing body 210. In some instances, by returning fluid to the same reservoir for reapplication or by utilizing bi-directional flow, increased binding of a molecule at a location of a substance spot on the application surface may be possible even with fluids in which the molecule is present in very low concentrations.

In further detail, substances may be moved through the individual flow cells (once formed) by any of a number of techniques, such as by pressure-flow, gravity-flow, electrokinetic processes, air pressure, and/or any other suitable method(s). In one specific example, creating pressure-flow and gravity-flow can be accomplished by using pumps and/or vacuums. When using a pair of body microfluidic channels 215 with a pair of source fluid openings 211, for example, if the pressure at a second source fluid opening 214 is lower than the pressure at a first source fluid opening 212, a siphon may be established for flowing a substance through the flow cell, with fluid contacting the application surface 130 at the flow chamber 290. Similarly, air pressure may be used, for example, to push a plug of a viscous gel along the fluid pathway to propel a solution, or a reservoir may be pressurized to propel the solution. In other examples, charged compounds, such as negatively charged DNA, can benefit from the use of electrokinetic pumps to move such charged substances within the flow cell for application to or interaction with the application surface. Additionally, in some instances, doped or coated interior walls of any or all of the various microfluidic channels can be used to increase or modify a charge, e.g., negative charge, which can act to reduce the friction between negatively charged substances and the interior of the conduits.

As mentioned, the applicator tip 280 may include a distal tip surface 286 that defines both interface portions that contact the application surface 130 as well as the flow chambers 290 that are used to pool fluid and interrogate or apply substance to the application surface. Though the distal tip surface that contacts the application surface is shown as being generally flat, other configurations can be used as well. For example, the distal tip surface can merely be the flow chambers defined by a bundle of microtubules. In this embodiment, if the orifices are circular, the distal tip surface could be in the form of a collection of rings that define individual flow chambers. Thus, the distal tip surface could include some open gaps between the collection of rings rather than be configured as a solid surface. These open gaps could remain open or could be filled with other material. For example, microtubules could be held together by an epoxy used to fill in the gaps between the channels, and the cured epoxy and the microtubules defining the flow chambers could then be cut and/or polished to form a smooth surface.

Regardless of the configuration of the applicator tip 280, the distal tip surface 286 may be pressed against the application surface 130 to form a seal about the flow chambers 290 so that the flow chambers may form a sealed chamber defined by recessed portions of the distal tip surface and the application surface. Typically, a fluid tight seal may be formed using pressure toward the application surface to prevent contact or cross-talk between spots when applied to the application surface. By preventing contact or cross-talk between substance spots, the microfluidic flow cell arrays 100 described herein can be suitable for applications that would benefit from internal referencing, which can assist in removing various types of noise that can be problematic with optical sensing systems that are intended to be highly sensitive to minimal surface plasmon resonance deltas.

The distal tip surface 286 (or spotter face) that interfaces with the application surface 130 can be any size or geometry. Without limitation, examples include distal tip surfaces designed to cover 76 cm×2 6 cm microscope slides, or any of a number of commercially available wafers, e.g., 25 mm, 50.8 mm, 76.2 mm, 100 mm, 125 mm, 150 mm, 200 mm, 300 mm, etc. Additionally, the distal tip surface can be designed to correspond to any substrate or structure on a substrate. For example, if an application surface includes ridges, the distal tip surface may be modified to have valleys that mate with the substrate ridges or vice versa. The distal tip surface may also be made rigid or be of sufficient flexibility to conform to an application surface. In some embodiments, the distal tip surface may be designed to facilitate integrating the spotter with an analysis platform. For example, the distal tip surface may be sealed effectively on an application surface that can serve as the transducer face of any of a number of analysis platforms, such as a surface plasmon resonance (SPR) system or a surface plasmon resonance imaging (SPRi) system.

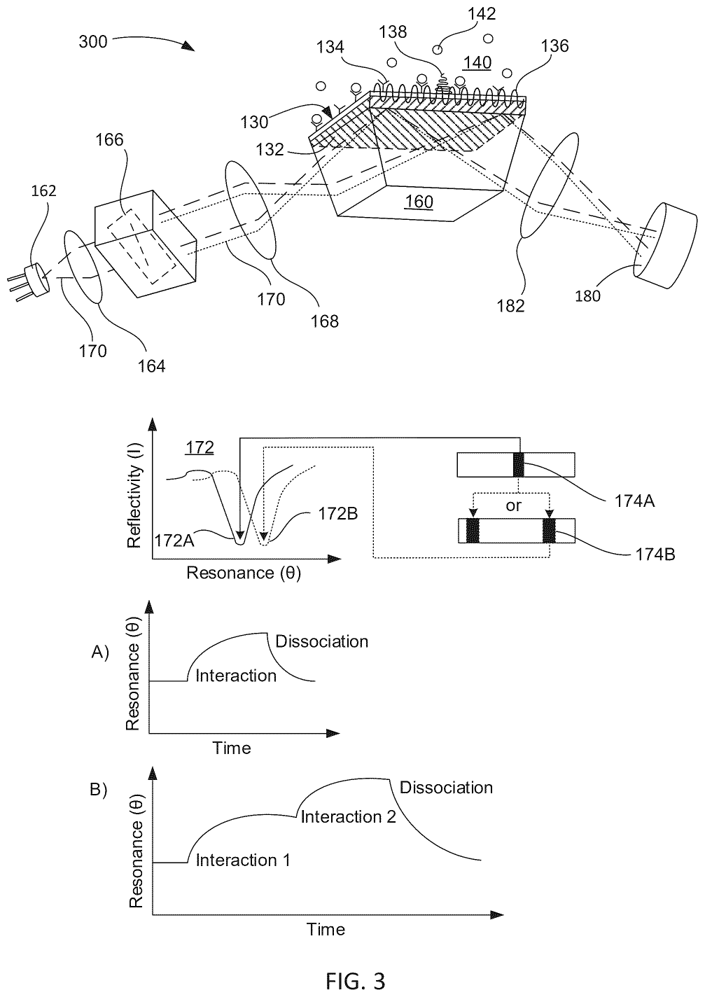

Referring now to FIG. 3, once the substance spotter system has applied substance spots to the application surface 130 (positioned on the sensor chip 132), an optical sensing system 300 (which can be an SPR system) can be used for the surface plasmon detection. This particular SPR system includes a light source 162 (or emitter), which can be a broadband source, a Light Emitting Diode (LED), a laser, other standard light sources, or in one specific example, a Superluminescent Diode (SLD). In some examples, the light source can be operable to emit wavelengths of light ranging from about 300 nm to about 1100 nm, 600 nm to about 860 nm, from about 700 nm to about 800 nm, from about 720 nm to about 860 nm, or from about 820 nm to about 860 nm. Wavelengths outside of this range can be used, depending on the application and scanning technology and setup. In additional detail, though these wavelengths work for many surface plasmon resonance systems, there are other wavelengths outside of these ranges that can also be applicable, depending on the scanning/sensing system(s) used. For example, interlaced angular scanning or other type of interlaced scanning can be operable outside of these ranges, including those that are operable within ranges inclusive of white light.

In this example, the light source 162 can be positioned to emit light energy 170, which in this instance can be collimated light, into a solid optical material 160, e.g., optical prism. In one example, the optical prism can be an isosceles trapezoid fabricated from Schott N-BK7 (Schott AG, Germany) or an optically equivalent glass. Other shapes of solid optical material can likewise be used, depending on the application. Regardless of the material choice, the material can be selected to provide compatibility with ancillary coating chips manufactured by third parties, such as XanTec Bioanalytics GmbH (Germany) or other chip manufacturers. In one example, the legs of the trapezoid (extending from the application surface) can form a 60° to 80° angle or a 65° to 75° prism side-wall angle, and the angle can be selected more specifically to coordinate with a nominal resonance angle at or near the center of a desired or predetermined dynamic range, or more specifically in this example, a desired or predetermined angular range, e.g., 0-4°, 0-3°, 0.2.5°, etc. In one example, setting the optical prism at an angle to be centered or near centered (e.g., within 5% of center) within the desired illumination angle range can help with minimizing optical aberrations and angle deflection losses due to refraction upon entering the optical prism, with reasonable angles of incidence being available on either side of the central location. Pivot points (not shown) may be present at locations where the optical prism angle can be set to be essentially centered within the desired illumination angle range. In some examples, the solid optical material can be pivotable to some degree for purposes of set up and/or operation, e.g., rough angular modification with fine angle adjustment up to about 3 to 5 degrees, for example. In additional detail, though FIG. 3 illustrates the light path passing through the end of the illuminator, alternative designs could be used. For example, the light can be shaped in the illuminator after which it passes directly out onto/into the prism.

In further detail, the properties of probe signal 170 (in this case light energy) can be adjusted using, for example, a tunable optical filter 166 to adjust the wavelength, or an optical deflector 166, such as an acousto-optical deflector (AOD), an acousto-optical modulator (AOM), or an electro-optical deflector (EOD). Element 166 of FIG. 2 can be any device, element or assembly that can change the properties of the probe signal as may be prudent as informed by the sample, type of test, and method of detection. As an example, an AOD can be used to change the angle of incidence for emitted light energy without passing through all of the intermittent angles in between, e.g., angle skipping. This can provide one mechanism that can be used efficiently for carrying out non-sequential scans in accordance with the present disclosure. In this example, the light source 162 (or light emitter) can pass light through a collimating lens assembly 164 to generate collimated light, with the angle of light being directed or redirected using the AOD. In some examples, additional lenses can be used, such as an illuminating lens or lens assembly 168, which directs the appropriate light onto the underside of the sensor chip 132. In some examples, the illuminating lens or lens assembly can be a telescoping lens assembly. In further detail, the relationship between the collimated light from the light source 162 and the reflecting surface, e.g., the underside of the sensor chip 132 opposite the application surface 130, can be adjusted roughly during set up by mechanical alignment, and then further adjusted with finer precision and quicker modification, e.g., even angle skipping, using the AOD to redirect the light energy using acoustics or electrical signals to modify a vector or direction of the light energy after emission from an emitter. Notably, the angle of light entering the optical prism as shown in FIG. 1 is exemplary only and does not necessarily depict an accurate angle of entry of the collimated light into or out of the optical prism. Rather, this arrangement is provided to merely show the components of the device. Though this particular example is based on the Kretchsmann configuration, the modifications described above and hereafter provide for systems and methods with certain enhanced properties. Furthermore, though the Kretchsmann arrangement is generally shown by example, other arrangements can likewise be used with the various printing, adjusting, detecting, and/or analysis systems described herein.

In further detail regarding the use of the optical deflectors to provide angle skipping of the light energy, an acousto-optical deflector (AOD) can provide for rapid variance of the angle of incidence (AOI) of a collimated beam of the light energy at the optical interface surface (opposite the application surface) of the sensor chip using acoustic energy to modify the AOI. Other optical deflectors can be used that can be rapidly adjusted with respect to AOI using electrical energy, such as an acousto-optical modulator (AOM) or an electro-optical deflector (EOD). As described herein, specific discussion of AODs can include related embodiments where an EOD or other rapidly actuatable deflector can be used. Thus, specific discussion of AODs includes other similar devices that can be used for rapid angular deflection. In further detail, the AOD, for example, can spatially control or angularly modify the collimated optical beam under typically constant power while modifying the acoustic frequency. Thus, the collimated beam can become more or less deflected based on the acoustic frequency applied. In one example, the deflection angle of the collimated beam output can be defined by Formula I, as follows:

$$θ = λ f V \qquad Formula I$$

where θ is the deflection angle, λ is the wavelength of the light energy, f is a controllable radio frequency at which the actuator of the AOD is driven, and V is the speed of sound in the AOD crystal. This equation can be used to characterize, along with systems of the present disclosure, the instrument's sensitivity and noise reduction capabilities. In greater detail, the light energy shown in FIG. 3 passing from the collimating lens assembly 164 through the acoustically- or electrically-actuatable optical deflector 166 can provide light deflected by the AOD at different deflection angles, but there can also be some light energy that remains undeflected due to diffraction efficiency losses.

After the light energy enters the solid optical material 160, e.g., optical prism, the light can be reflected from a reflecting surface of the sensor chip 130, which can include a thin metal film, coupon, grating, etc. The sensor chip, in some instances, can be a modular removable coupon or grating or some other structure that is removable and/or can be placed on the solid optical material, and in other instances, can be joined or fastened to the optical prism with adhesive, applied as a film, that can be fastened to the solid optical material, etc. As shown, the reflected light is then captured or sensed by a detector 180 (or camera, which can be a video camera, for example). The detector can have an impact on noise, particularly when it relates to the illumination levels of the system, e.g., dark noise vs. shot noise vs. quantization vs. periodic noise. In accordance with the present disclosure, one aspect of the camera or detector that is used is its ability to form an image and to detect light across a range of incidence angles. If a particular type of camera or detector introduces periodic noise, for example, then interlace scanning can help to decouple that from the angular scanning, making the choice of detector less significant. In some examples, a frequency domain notch filter can assist with reducing periodic noise, which could be used in addition to the interlace scanning described herein. In accordance with this, example detectors that may be used include complementary metal-oxide semiconductor (CMOS) detectors, charge coupled device (CCD) detectors, or other similar detector platform. For systems not described in this example, detectors 180 of various types can be used which are appropriate to the probe signal type or the signal emitted from the sample after stimulation by the probe signal, e.g. light, electrons, ions, etc.

If further detail, the detector 180 can be sensitive to light intensity, polarity, and/or other properties of the light which can be sent to a computational system for analysis and/or display. The angle of reflection is the angle at which the reflected light leaves the optical interface surface and can be adjusted to find a resonance angle(s) for SPR systems, which is/are the angle(s) at which the beam of reflected light is primarily absorbed by the electrons of a sensor chip at a given location on the surface. The angle of incidence refers to the angle of the incoming light energy beam relative to the prism surface and that leads to reflection from the optical interface surface of the sensor chip. Again, when carrying out a non-sequential scan, the angle of incidence can be adjusted to skip angles using an acousto-optical deflector (AOD), an acousto-optical modulator (AOM), or an electro-optical deflector (EOD) 166, for example.

When configured for SPR, a baseline reading can be taken, which may or may not include a supplemental coating 132 such as dextran coatings, carboxymethyl dextran coatings, hydrogel coatings, polyethylene glycol/carboxyl coatings, nickel nitrilotriacetic acid coatings, hydrophobic alkyl coatings, polycarboxylate coatings, protein coatings, self-assembling monolayer coatings, streptavidin coatings, etc. Substances applied to the surface may include, for example, immobilized ligands 134 that may be applied using the microfluidic flow cell array or may be pre-loaded on the sensor chip. Resonating electrons resulting from surface plasmon resonance can be referred to as surface plasmons, as shown by example as plasmon wave 136. The location of the (initial) resonance at the detector 180 can be established based on the location of the minimum of an initial reflectivity dip 172A in the SPR Reflection Intensity Curve 172, which can also be represented by an initial dark band 174A in the corresponding SPR image indicating the area on the detector where resonance is detected, e.g., reduced reflection due to resonance of the sensor chip. After interaction between an analyte 142 and the ligand(s) on the application surface 134, both the resonance dip angle and the image location where resonance occurs may shift over time to the right or left, as indicated by a second dark band or SPR image dark band 174B, and further illustrated by SPR dip 172B. The shift in angle over time can provide information about the interaction between any of a number of substances that may be present on the application surface. Notably, the resonance indicated by the second dark band is not static but can move laterally over time as the interaction dynamics between analyte and ligands on different ROIs on the application surface change. These interaction dynamics can lead to some of the issues that can be solved by the non-sequentially scanning methodology described herein.

In more specific detail, the SPR Reflection Intensity Curve 172 can plot reflectivity (refractive index, I) against the resonance (or absorbance) angle (θ) of the sensor chip, e.g. metal (gold or silver) film or coupon. Thus, the shape and location of the SPR dip minimum can convey information about the application surface via interaction with the optical interface surface prior to introduction of the analyte. As the angle of resonance (SPR dip) dynamically shifts, additional information can be gathered when the new angle of resonance is compared to the initial readings. For example, as a sample fluid 140 with an analyte or probe substance of the sample fluid is passed along the application surface 130 of the sensor chip 132 (which may include a supplemental coating), the ligand associated with the application surface 134 interacts with the analyte 142 and the dark band in the SPR image appears and becomes darker while simultaneously the minimum of the SPR reflection intensity curve shifts to the right or to the left. The new angle where SPR dip (maximum resonance) occurs can be referred to as the surface plasmon resonance angle (which may shift to the right or the left). Referring again to the application surface (the surface opposite the reflecting/optical interface surface), an evanescent wave 138 is shown illustrating that as the substance or analyte, carried by fluid, gets closer to the application surface, the sensitivity is increased. Thus, in one example, interactions can be evaluated within about 100 nm or within about 200 nm of a surface of the sensor chip (or supplemental coating that may be present to assist with attaching ligands to the application surface of the sensor chip). This represents a reasonable range, particularly for SPR applications. On the other hand, other systems may provide different ranges. For example, a plasmon waveguide resonance (PWR) chip may provide additional range of up to 1 mm, e.g., about 200 nm to about 1 mm). As a note, the analyte, in some examples, can be referred to as a target, probe, or generally as a substance. Furthermore, there may be one analyte, target, substance, etc., used in an assay, and thus, can be referred to herein as a “first” substance, “second” substance, “third” substance, etc. respectively. Substances can be present on or applied to a sensing substrate, or can be applied as a spot, e.g., droplet, printed spot, pin-spotting, etc., within a fluidic sample, or by any other technique sample application or interaction.

SPR can be used to observe time dependent interaction between ligands and analytes or probes. By monitoring response over time, kinetics of molecular binding can be evaluated and characterized. Kinetics can be shown by plotting the resonance (or absorbance) angle (θ) against time, forming sensorgrams. The magnitude of the units of time used can depend on the interaction speed. This is shown by simple example in FIG. 3 at graph A. As an interaction starts at the beginning contacting an analyte or probe with a ligand, initial binding tends to be more rapid because there are more sites available for binding. Once the sites begin to fill up, the binding slows down and may eventually level off as equilibrium (binding to unbinding) occurs. Dissociation begins to occur when analyte introduction slows, stops, or a disassociate chemical or wash is introduced. In a simple example, an associate constant (Ka) and a dissociation constant (Kd) can be determined and a ratio (Ka:Kd) can be established. Other types of information can also be determined, as previously mentioned. In further detail, in graph B, two interactions may occur, such as when two materials are sequentially introduced. Thus, there are a variety of types of experiments or interactions that can be conducted using resonance information compared to time, many of which are not specifically shown in this FIG. Notably, the generation of a sensorgram can be carried out using non-sequential scanning followed by reassembly of the resonance curves, e.g., sequentially, which can be used to generate a region of interest (ROI) resonance curve with reduced noise, as described in greater detail hereinafter.

As SPR techniques have emerged as good analysis tools for substances applied to a surface, the performance of the SPR detection is often associated with high-speed data analysis. In connection with this, when data is collected, curve-fitting of the SPR data collected is a process to determine the performance of the SPR sensing, among other things, e.g., distinguishing the SPR measurement from other direct measurement technologies. When collecting data using angular interrogation, an SPR curve indicating reflectance intensity against an incident light angle provides a way to analyze the binding kinetics of analytes or other substances on an application surface of an SPR system. The substance is typically applied to a region of interest (or ROI). In further detail, a reference region where a substance has not been applied typically yields the minimal light intensity or reflectance in the SPR image, and the angle at which this minimal reflectance for the reference region occurs is often referred to as the SPR angle. Likewise, an ROI where a substance has been applied typically yields minimal reflectance at a different SPR angle. From this, changes in refractive index, at the ROI and reference, can be used to generate resonance curve data for each, which monitors and maps changes of reflectance intensity over a range of incident angles. Because the angle scans used to produce the data for these resonance curves (dips) happens over the time of the sweep or scan, and the reference and ROI SPR angles are different, the SPR angles are measured at slightly different times depending on the scan rate. To obtain an accurate measurement of the SPR angle of an SPR curve, various methods can be used, including curve fitting methods, e.g., polynomial fit methods, centroid methods, parabolic fit methods, etc. Other methods can include optimal linear methods, asymmetric methods, and signal processing methods. After each sweep the SPR angles of the reference region(s) and ROI(s) are determined from the best curve fit of the data, and then the values of the SPR angle for multiple sequential sweeps can be averaged to further minimize noise.

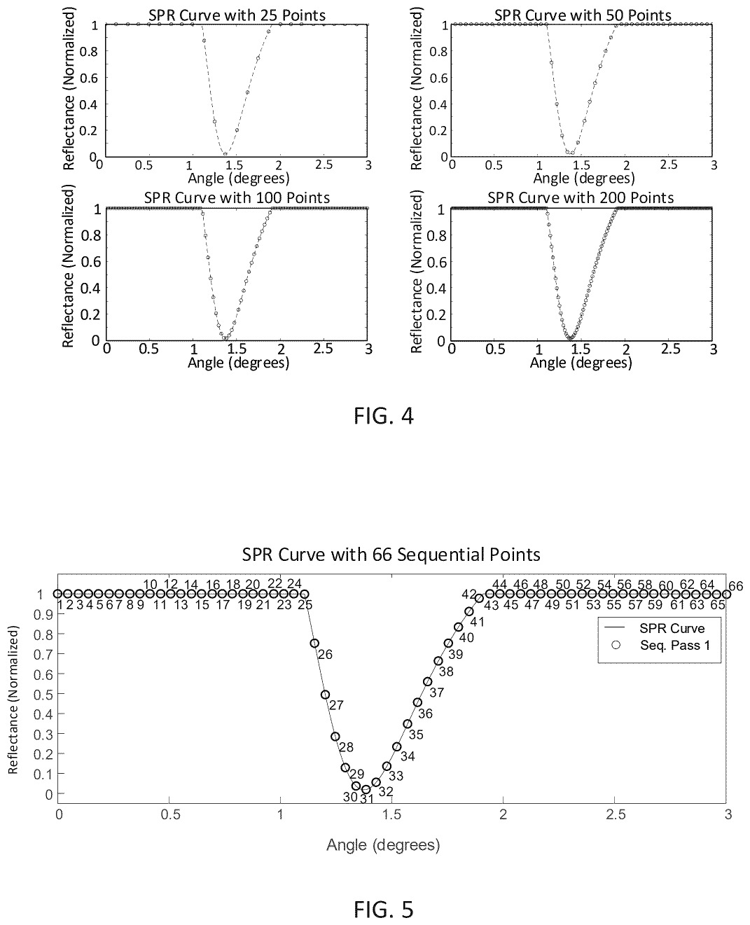

In connection with this, an example of curve fitting and signal averaging is shown for an example SPR curve in accordance with the present disclosure. Curve fitting can be carried out using an SPR resonance curve. It should be noted that these discussions can be applied to more general data sets or curves captured by other technologies, some examples given previously. In FIG. 4, an SPR curve is shown that can be created by capturing a different number of data points (angle positions) per scan at 25, 50, 100, or 200 then fitting a mathematical curve to a given region of reflectance change (SPR dip). A typical span (width) of an SPR dip is about 0.3° to about 0.8° (typically about) 0.5° of the entire angular range of the sweep, e.g. about 3°. The angular range is the overall change in the angle during each sweep from about 0° to about 3°, or a change of about 3° starting at an arbitrary starting location, for example, at the starting location of 45° the angular range would be from 45° to 48°, for a starting location of 60° the angular range would be from 60° to 63°, and so forth.

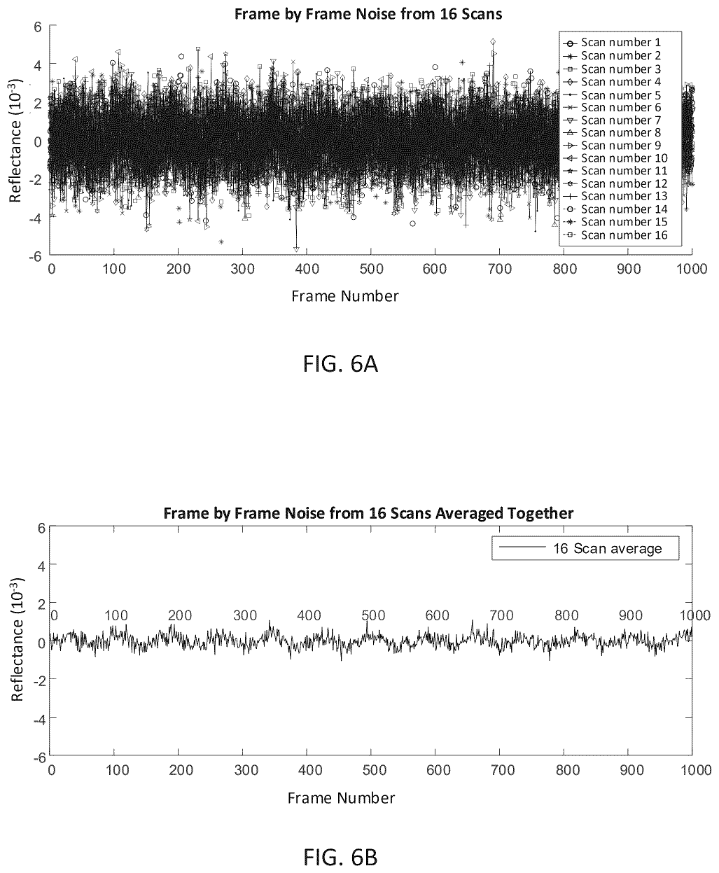

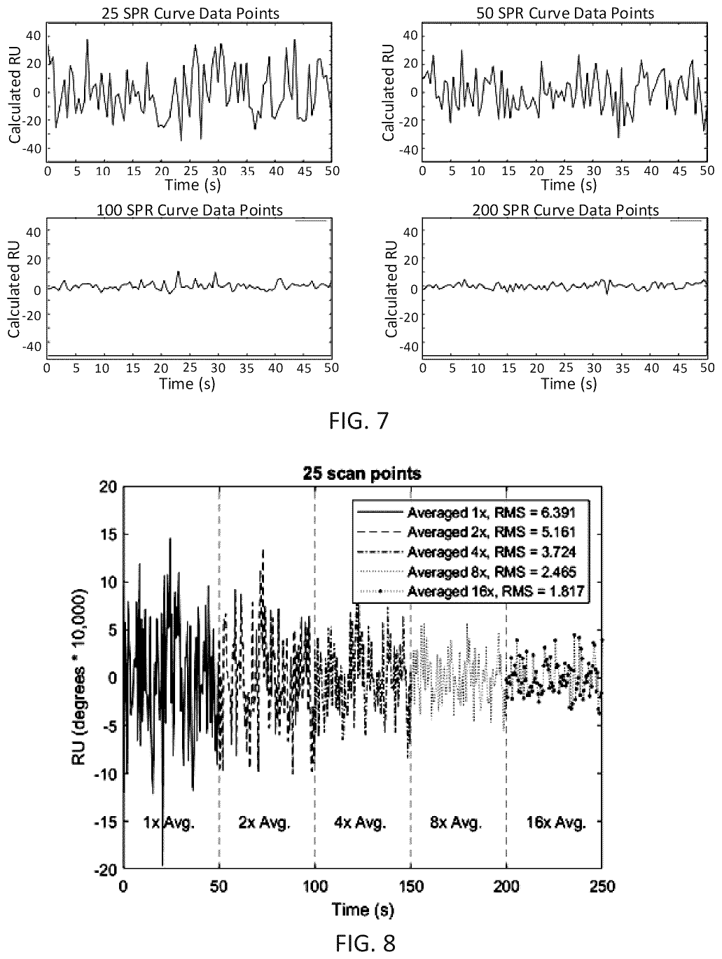

FIG. 5 shows how this is done in traditional SPR scanning routine with a sequential capture from left to right, as illustrated with 66 frames (data points corresponding to angle positions) across a 0° to 3° angular range. FIG. 6A shows the reflectance noise scaled at 1000-fold (10⁻³ reflectance) that may occur throughout a single scan across 200 frames, along with 16 scans overlaid on top of each other. FIG. 6B shows how averaging this 16-scan noise structure into single scan results in reduced variation from the frame-to-frame measurement resulting in greater curve fitting precision. It should be noted that the SPR angle determined by the curve fit is used to calculate the response (measured in response units, RU) used in composing the sensorgrams like those shown in FIG. 3A that track the progress of the analyte-ligand interactions over time. FIG. 7 illustrates how single SPR curve scans with 25, 50, 100, or 200 data points (frames) per scan result in different SPR sensorgram noise levels (plotted as calculated resonance unit (RU) versus time).

There may be two competing priorities with this type of arrangement, namely i) high resolution SPR scans to achieve improved linearity, precision, and accuracy of a single SPR curve (up to the maximum linearity, precision, and accuracy) versus ii) high signal averaging of multiple scans to achieve good precision and resolution from one data point to the next (up to the maximum precision and resolution) to achieve lower noise or the lowest noise possible on the resulting sensorgram plot over time. As an example, achieving high resolution for increased (even maximized) linearity, precision and accuracy may include capturing at least about 20 data points (angle positions) per SPR dip (within the 0.5° span) and about 120 or more data points covering the full dynamic range of the scanning sweep (sequential scanning). Typically, a higher number of data points captured per sweep gives more accurate SPR angle values. On the other hand, high signal averaging of many sweeps can provide for maximum precision and resolution (lowest noise) in an effort to keep the signal noise as low as possible (limited by design, environment of system, etc.). Often, averaging about 10 or more sequential scanning sweeps can help with averaging out random variation due to uncorrelated noise. Uncorrelated noise scales down as √n (where n is the number of sweeps), but correlated noise is not typically reduced. Thus, a higher number of data points per sweep is better with respect to resolution and accuracy, but too many data points captured per sweep can slow down the data acquisition process and yield diminishing returns by taking significantly longer to do enough sweeps to apply averaging to get the desired signal to noise ratio.

One can also run into physical limitations with respect to the number of possible scan angles, e.g. in the case where an LED array is used for illumination, or a photo-diode array is used for signal capture, it is cost and space prohibitive to add more diodes. High signal averaging involves achieving signal noise at levels as low as practical or possible, which can be limited by the design of the system and the environment in which the system is capturing data points, e.g., frames. Typically, an average of 10 or more sweeps can be averaged to reduce the noise due to random variation (scales as √n, whereas correlated noise is not typically reduced). Thus, in order to quantify the differences between curves, such as a reference resonance curve and a region of interest (ROI) resonance curve, resonance angles can be determined by curve fitting, for example, as illustrated in FIGS. 4-7.

As mentioned, a surface plasmon resonance (SPR) curve can be used to generate sensorgrams to observe time dependent interaction between ligands and analytes or probes. As an example, as an SPR curve includes a resonance angle range along the x-axis and reflectance along the y-axis, a sensorgram can be extrapolated with time along the x-axis and Resonance Units (RU) along the y-axis where a one degree (1°) change in the SPR angle is equivalent to 10,000 RU. In short, a sensorgram relates to plotting the resonance (RU) value over time, with the RU value determined using the SPR angle change from the SPR curve. Examples of sensorgrams are shown at FIG. 3 at A) and B), as described previously.

FIG. 8 shows how for a scan resolution of 25 data points, e.g., frames, per scan, the resulting sensorgram noise is reduced by increasing the number of scans averaged from 1×, to 2×, 4×, 8×, and 16× successive scans respectively. The advantage is that sensorgram noise is decreased from about 7.3 root mean square (RMS) with no averaging to about 1.8 RMS at 16× averaging, however the cost is that the number of SPR curve data points used to calculate each sensorgram data point may increase from 25 SPR curve data points per scan to 400 due to averaging (16 scans×25 SPR curve data points/scan). For example, using a 1 millisecond per SPR curve data point data rate, averaging results in 16× reduction in sensorgram data point frequency from 40 Hz to 2.5 Hz. In a second example, using 200 SPR curve data points per scan, while using a total of 400 SPR curve data points to generate the sensorgram data points, would allow no more than 2× averaging to achieve the same data rate.

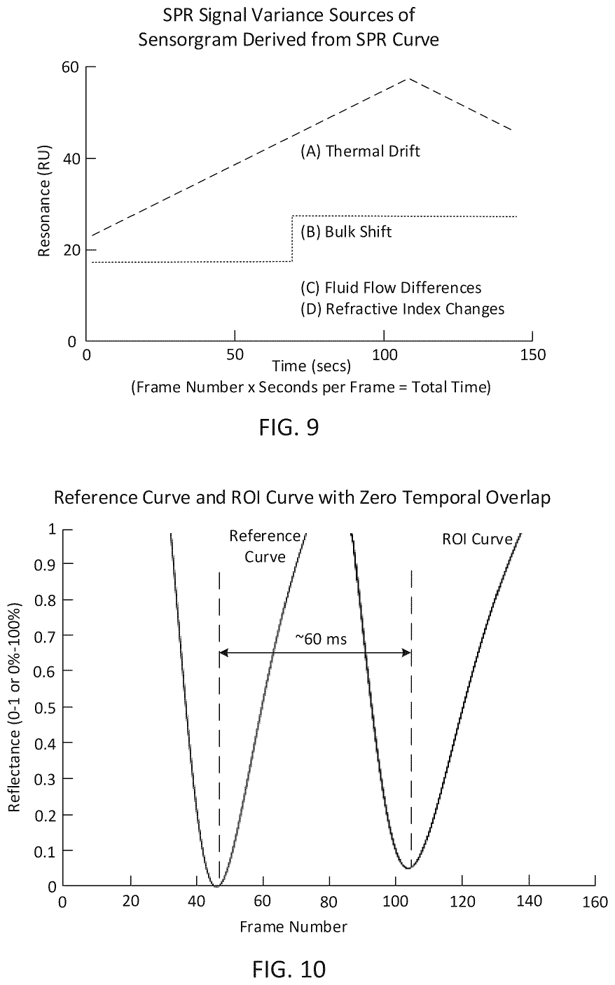

With this in mind, sensorgram curves can also be impacted by variances introduced by a number of sources present while collecting data to generate the SPR curves (used to generate the sensorgrams) that should be corrected in accordance with the present disclosure. FIG. 9 illustrates various types of SPR signal variance that can occur that is often inherent in the experimental design or instrument operating environment etc. In FIG. 9 at (A), an example of the impact of thermal drift is shown. When collecting data, thermal drift can be an issue in that as temperatures change, shifts in response units or resonance units (RU) may occur. For example, in some systems, a small change, e.g., one degree (Celsius), at the application surface of an SPR system can cause about a 100 RU shift. This can also be true with other technologies that utilize an application surface or another type of scannable substrate, e.g., small volume container, etc. The source of thermals can be from a number of sources, such as the application surface, optics (camera, light source, etc.), which can shift the refractive index of the solid and fluid materials, shift the incidence angle relative to the reference resonance angle, shift the light intensity, the light wavelength, the polarization state of the light, etc. Thermal drift can occur fairly rapidly, and in the example shown in FIG. 9, a shift of about 35 RU is shown within a time frame of about 110 seconds (secs). Such thermal drifts can thus ripple and/or change when simply turning equipment on or off, starting or stopping an experiment, or just time of day heating and cooling cycles. Also shown at (B) is an example of a bulk shift that can occur. To illustrate, when switching from one solution to another (with a different refractive index), the sudden change in refractive index can shift the curve more abruptly. Notably, fluid flow differences can occur when using SPR instrumentation, which may have an impact on thermals, pressure (shear force), and refractive index. As true signals can shift at a region of interest (ROI) by these or other factors, a reference region (at location without the substance of interest or spot applied) is often used for comparison so that the shift can be corrected by subtracting the reference sensorgram data from the ROI sensorgram data, which can result in the cancelling out of these and other variances that may otherwise be present. Even taking those factors into account, there can still be noise present that should be removed, which is the subject of the present disclosure.

Referring now to FIG. 10, two surface plasmon resonance curves (or SPR curves) were generated, namely a reference SPR curve and a region of interest (ROI) SPR curve. The ROI SPR curve typically represents a mathematical fit of the measurements made at various angles of incidence and enumerated by frame numbers shown along the x-axis. ROI SPR curves occur where a substance sample has been deposited on an application surface of an optical scanning system (similar to that shown in FIG. 3). The reference SPR curve is captured the same way, but is generated at a location where the substance sample has not been deposited, e.g., a bare/unprinted portion of the application surface for comparison and subtractive noise reduction. The y-axis represents the reflectance data collected, where 0 (or 0%) indicates no reflectance signal detected and 1 (or 100%) represents 100% signal saturation.

As shown in this example, there is about 60 milliseconds (msec) of difference in time between when the data at the minimum (dip) of the reference SPR curve was captured compared to the dip of the ROI SPR curve (based on a system that collects 1 frame per millisecond within a 0°-3° dynamic range of angles (or angular range) of incidence and the dips are separated by 60 frames). These SPR curves lack temporal overlap relative to one another along respective curve structures which can be problematic for noise reduction. As an example, the difference between the angle of incidence used to capture the reference resonance curve and the ROI resonance curve in this example was about 11,250 RU (where 10,000 RU is equivalent to about 1°). Thus, in this example, there is a considerable difference in angle of incidence at which SPR occurs and therefore a considerable difference in time between capture of the data in both of these curves. With this amount of angle of incidence difference and time difference between the reference region and the ROI, correlations of these two curves for purposes of subtracting noise from the reference SPR curve and from the ROI SPR curve can be problematic.

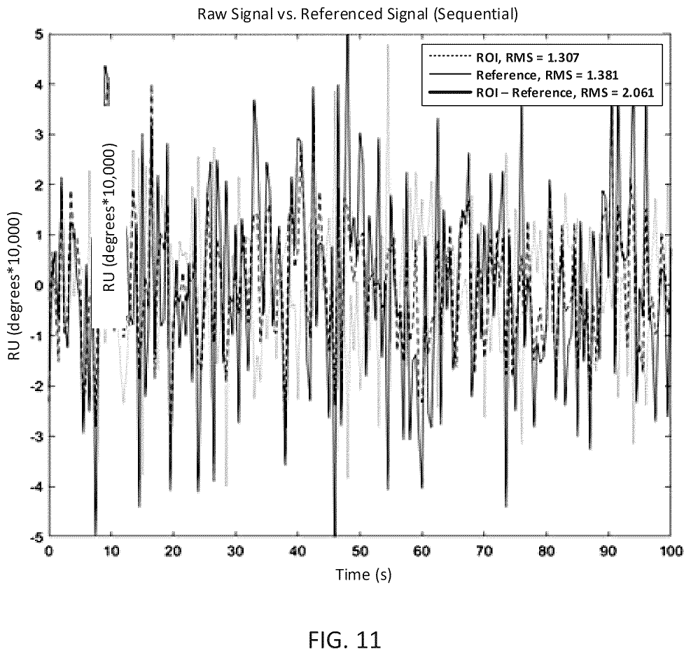

Referring now to FIG. 11, three (3) sensorgrams are shown, ROI, Reference, and ROI-Reference (reference corrected ROI data from which the Reference data values have been subtracted) are plotted. The ROI sensorgram shows the baseline corrected noise structure (mean RU value was subtracted to vertically center the sensorgram at zero on the y axis) of the data collected for the ROI spot. The Reference sensorgram shows a similar baseline corrected noise structure of the data collected for the Reference region. Subtracting the reference value from the ROI value should eliminate any noise that correlates between the two curves. While this example does not illustrate subtraction of bulk RU shifts in the sensorgrams (variation which would typically change on the scale of seconds to hours), it does illustrate that there exist faster time-varying noise fluctuations at the timescale of microseconds to seconds which are not eliminated. Whereas the RMS noise level for the ROI and Reference region are both about 1.3 RU RMS, the referenced value (ROI-Reference) increases to about 2.1 RU RMS.

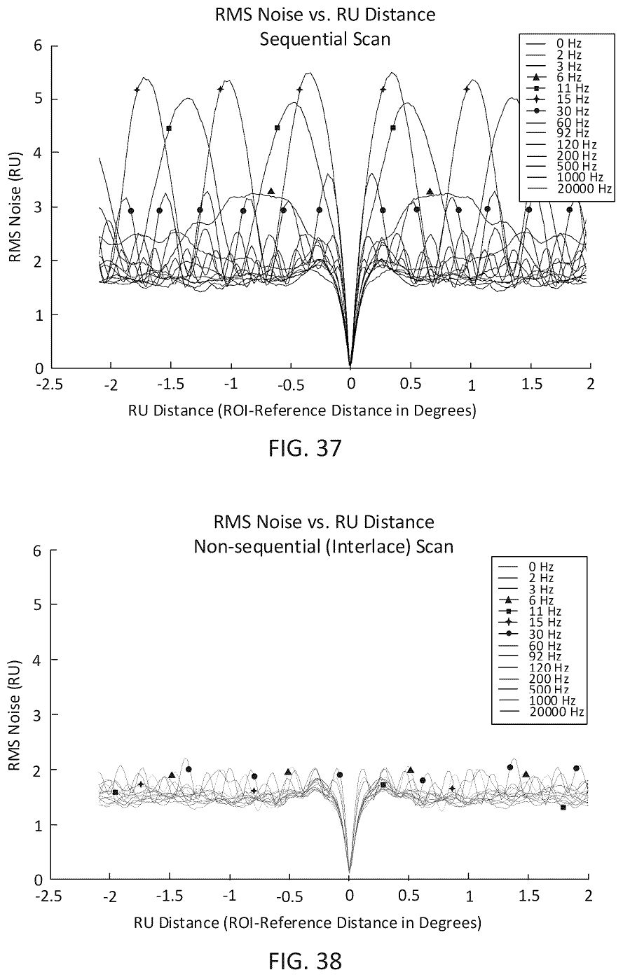

The extent to which referencing increases or decreases the noise can depend on the angular separation between the two curves and any resonant frequencies encountered in the system. FIG. 37, illustrated and described hereinafter, illustrates how the resulting referenced RU RMS noise value can vary from near zero when the reference and ROI curves have no angular shift (and therefore no temporal shift) between them, to a range illustrated in this example (FIG. 37) from about 1.8 RU RMS as the baseline noise which peaks at about 5.5 RU RMS. This equates to about 3.05× baseline RMS noise levels where measurements are taken with an angular shift (or temporal shift). In instances where particular periodic noise frequencies align with resonant frequencies of the sequential scan capture rate, RMS noise levels can increase even more, e.g., as high as 4× the baseline RMS noise levels or more. FIG. 37 will be described in greater detail hereinafter as a comparative sequential scanning example contrasted with the much lower RMS noise present using non-sequential (interlace) scanning as shown in FIG. 38.

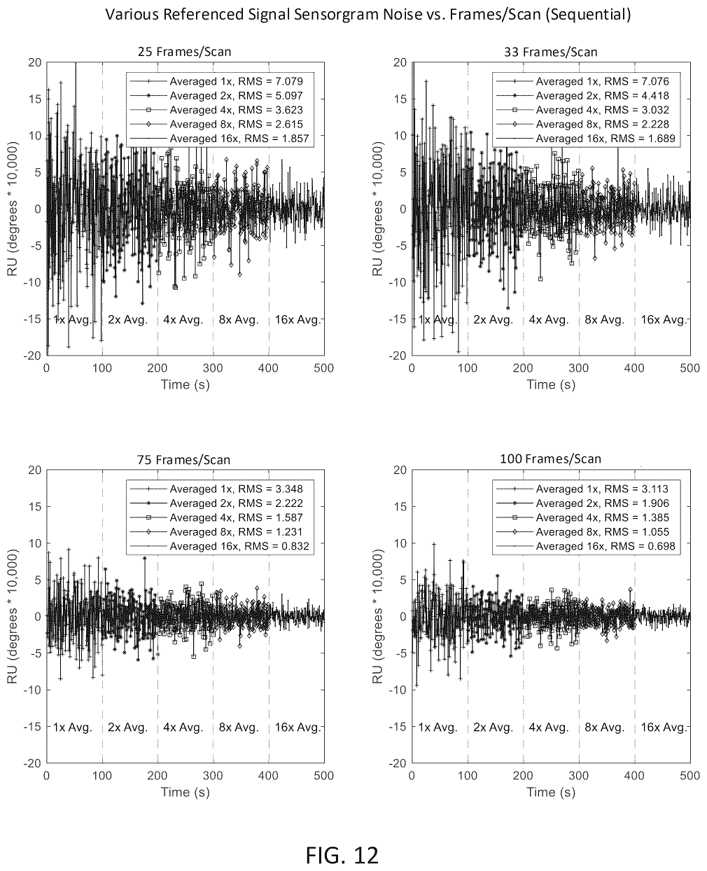

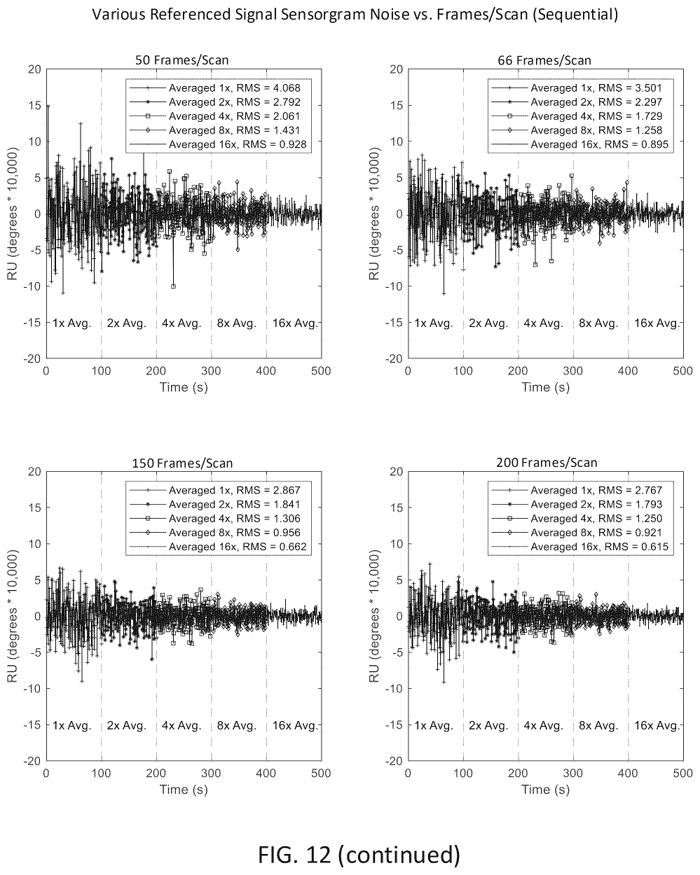

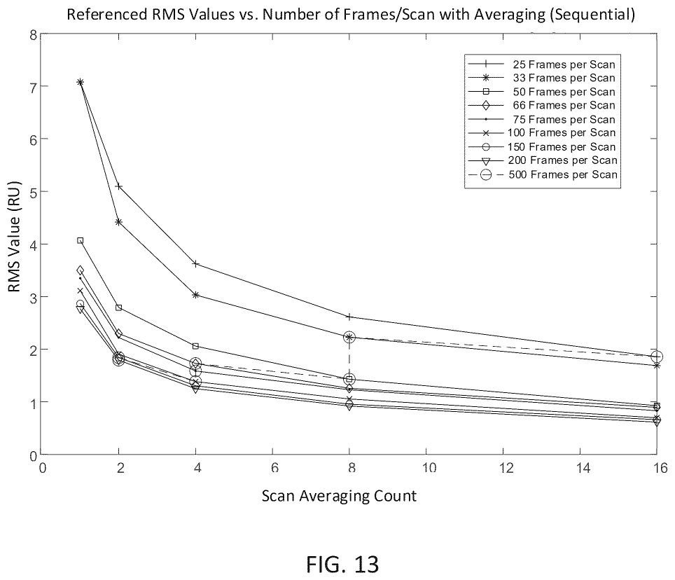

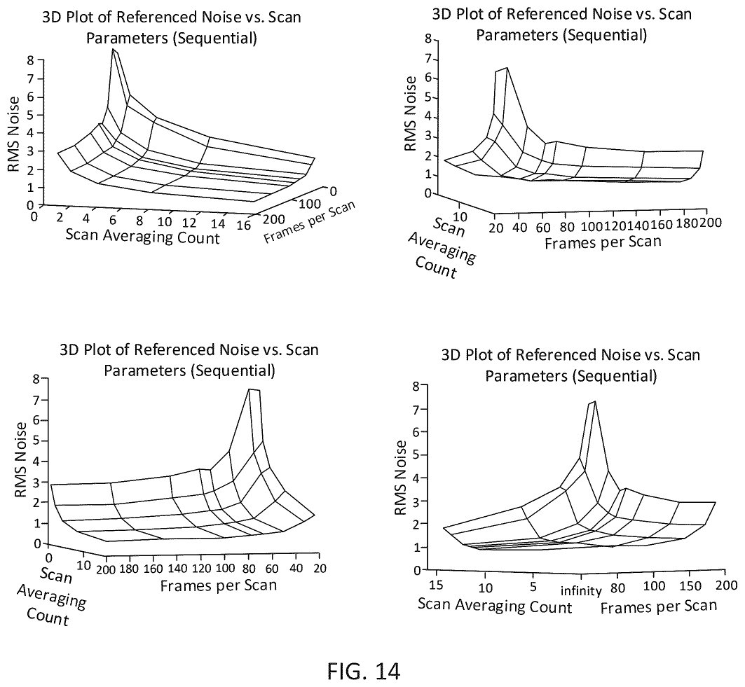

Returning now to FIGS. 12-14, these plots illustrate the trade space between the resulting referenced and corrected sensorgram noise and either the number of frames per scan or the number of scans that are averaged per datapoint for two SPR curves separated by about 6,000 RU or 0.6°. More specifically, FIG. 12 shows how the referenced noise decreases from as high as 7.3 RU RMS with 25 frames per sweep 1× average to as low as 0.61 RU RMS at 16× average of 200 frames per sweep respectively. FIG. 13 provides a 2D graphical representation of the resulting RMS sensorgram noise on the y-axis (measured in RUs) for each possible combination of scan averaging on the x-axis. Each plotted dataset in FIG. 13 represents the frames/sweep as indicated in the legend. For reference, assuming a maximum of 500 frames per sensorgram data point calculation, a dashed line with larger open circle markers is included in FIG. 13 to indicate the minimum RU RMS value achievable within each different frames/sweep dataset. Optimization under the limit of 500 frames per sensorgram data point is indicated by the circle with the lowest RU RMS value which in this example would be 100 frames/scan averaged over 4 subsequent scans, (interpolating between numbers one would intuit 5× averaging would be the best combination). FIG. 14 shows the same details as FIG. 13 but in a 3D graphical form represented from 4 different viewpoints.

One solution to reduce the resulting referenced RU RMS noise is to shorten the amount of time between collecting the reference signal data and the ROI signal data, making subtraction of the time-varying noise more accurate. However, with conventional sequential scanning (or sweeping) balancing the reduction of the time difference and maintaining good fidelity can lead to tradeoffs that may not be acceptable. For example, reducing the time between the capture of these two curves could be accomplished by reducing the number of frames, but that will result in reduced fidelity of the scan. In other words, the collection of a higher number of frames can provide better scan fidelity of the respective SPR curves, but that also means more time between the gathering of the respective SPR curves. Collecting fewer frames may reduce the time between the collection of SPR data for both curves (thus making the noise profile more similar for subtraction), but this occurs at the expense of good curve fidelity and sensorgram linearity as SPR angle values become harder to determine To illustrate further, if a reference SPR curve and an ROI SPR curve were theoretically captured at the exact same location at the exact same time (using the exact same frequency and other settings), then theoretically the noise could be the same. As this is governed by the differences in the amount of ligand and analyte captured on the ROI relative to the reference region, controlling this angular and consequent time difference is not always feasible. The goal of the present disclosure is to decouple at least the time variable between the scan data points, e.g. resonance, interferometry, etc., used to fit the reference SPR curve and the ROI SPR curve, e.g., reduce the time difference to less than about 5 milliseconds or less than about 1 millisecond, if possible, so that the acquisition can be as close as possible when collecting resonance data from the reference region and the ROI.

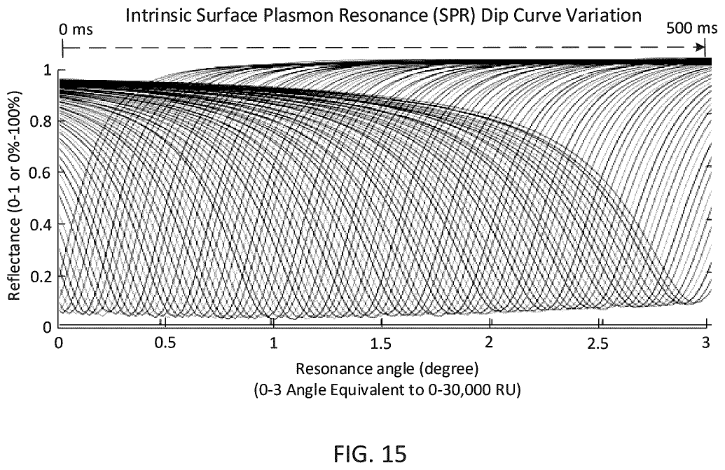

In addition to timing limitations that may occur when collecting the data for two curves, e.g., from the reference region and the region of interest (ROI) where the substance sample has been deposited on the application surface, the tradeoff between fast data collection and retaining good fidelity is complicated further by the resonance dynamic range (or angular range in this instance), e.g., from 0°-3°, used to collect the data. FIG. 15 illustrates SPR resonance curves modeled throughout the 0°-3° angular range and shows variation in curve width and symmetry at steeper incidence angles. These curves were used as a reference basis for quantifying the impact of resonance noise on the curve fit and RU calculation process. A modeled data set like this would be difficult to produce in actual physical form, so modeling is the method of preference for illustrating the impacts of noise variation on resulting RU calculations. It also facilitates control of the exact noise profile across data sets to isolate individual types of noise and their resulting effect on datasets (or curves generated from these datasets) distributed throughout the angular range. Note that this data was modeled after an optical calibration process, so was not collected on an application surface. However, 100 curves are represented, with each spaced about 300 RU (0.03°) apart. The purpose of this illustration is to show how curves can occupy the angular range. This indicates that referencing at a closer location to the ROI is typically better than at more remote locations. This also indicates that scanning in time generally can be problematic because not all data is captured at the same time and artifacts of mismatch in noise structure at the time each data point is captured can increase variation between the reference region and the ROI. This also indicates that reference and ROI shapes can change, so the amount of noise each curve picks up can also vary, e.g., one scan may include 30 data points while another include 40 data points.

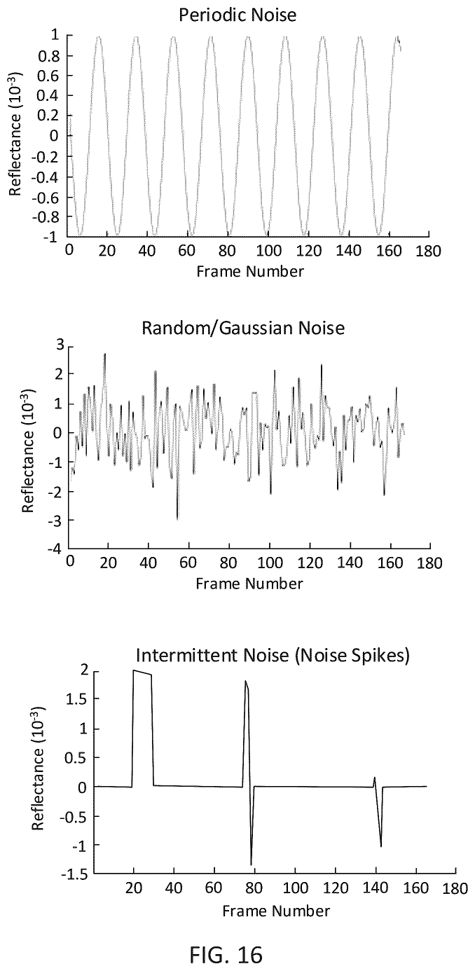

When collecting resonance or reflectance data using SPR optical detection as described herein, as the reflectance data to be collected relies on very minor changes in reflectance, even a small amount of noise introduced during collection of the data can be problematic. FIG. 16 illustrates three unique types of noise that can be introduced when collecting reflectance data from an SPR optical system. Each of these types of noise, namely periodic noise, random (or Gaussian) noise, and intermittent noise (noise spikes), present a different challenge in removal from data collected at a region of interest (ROI). Simple subtraction of noise collected from the reference region may not result in reliable curve data at the ROI. Stated another way, the presence of noise makes it difficult to cleanly subtract the curve data collected at a reference region from the curve data collected at the ROI due to a number of factors, such as the amplitude of the noise, the frequency of the noise, the randomness of the noise, the duration of the noise, etc. For example, variation of these three types of noises (periodic, random, and intermittent) between the reference region and the ROI can be introduced by several factors including; differences in the angles of incidence of light due to different locations of the reference region and the ROI on the application surface, differences in the light properties such as light intensity (which also changes with angle), changes in time frames between collection of reference data and ROI data (where increased time difference typically becomes less reliable), etc. Notably, random noise and intermittent noise can be more difficult to remove by their nature, particularly after the data has already been collected. This is because these types of noises have a more unpredictable noise profile. With that stated, one advantage of non-sequentially scanning substances at an ROI(s) and at a reference region(s) (carrying out optical scanning in a way that introduces less of a time difference) relates to the modification of the periodic noise and the intermittent noise (spike noise) to make it appear more like random noise, which by its nature is less problematic. Thus, by collection of resonance data using the non-sequentially scanning methodology described herein, and carrying out appropriate curve fitting, a new noise profile can be generated relative to the SPR angle where the periodic noise and the intermittent noise are present with a curve appearance of composited random noise.

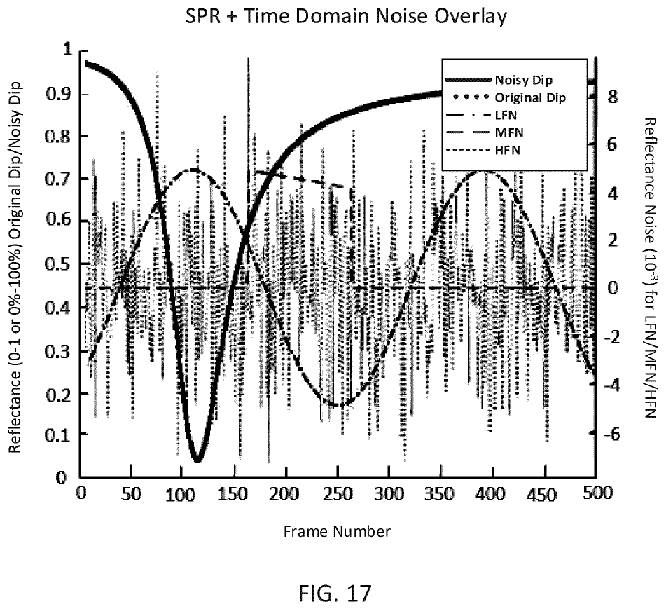

Referring now to FIG. 17, an example graph of SPR data modeled over 500 milliseconds (msec as time domain) at 1 millisecond per frame, with the x-axis providing the frame number of the scan, is shown. The y-axis on the left side illustrates the reflectance ranging from 0 (0% reflectance) to 1 (100% saturation) with “Noise” and “Original” plotted on the left axis. From the graph, it is difficult to see that the dip curve (original) tracks the noise data fairly closely (jittering up and down relative to the original dip curve). In this example, by subtracting the noise dip curve from the original dip curve, the result is the various types of noise plotted as LFN, MFN, and HFN along the y-axis on the right side. Notably, the scale of the noise plotted as LFN, MFN, and HFN has been expanded 1000-fold (10⁻³) so that the noise remaining is more apparent. In this example, LFN refers to low frequency noise which appears most like periodic noise, MFN refers to mid-frequency noise which appears most like intermittent noise (or spike noise), and HFN refers to high frequency noise which appears most like random noise (or Gaussian noise).

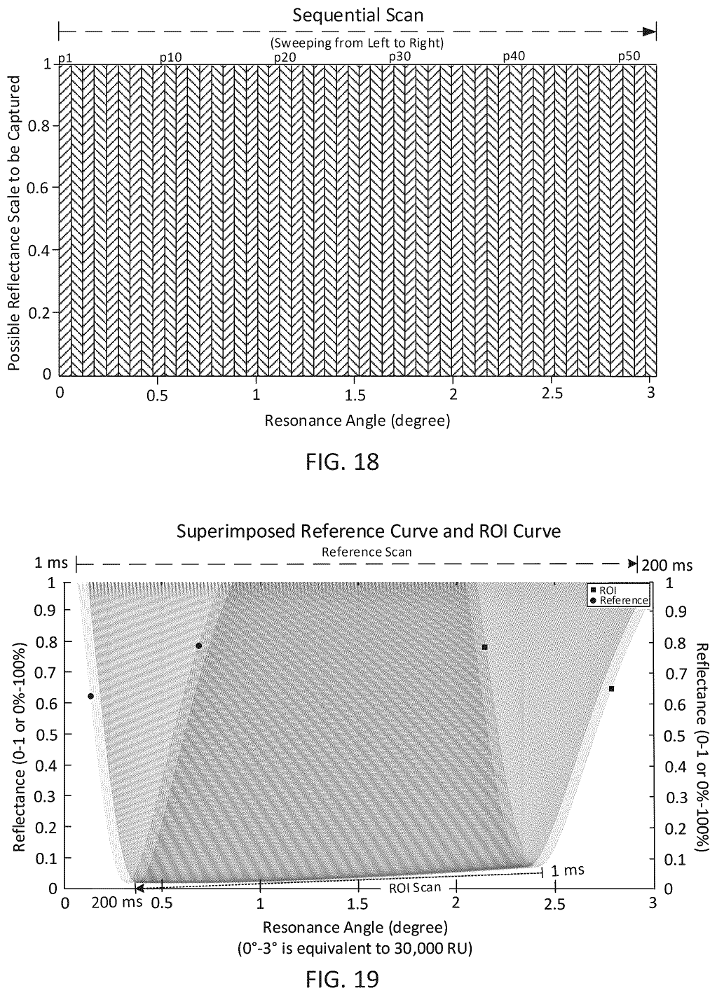

FIG. 18 illustrates an example standard sequential scan (sweeping from left to right). Example data that may be collected using this approach is shown by way of example at FIG. 5. With this sequential scanning approach, each angle of incidence scanned is shown by way of example by the individual vertical bars on FIG. 18, or by a numbered circle along data points of the curve on FIG. 5. With sequential scanning, every position is captured in order, e.g., position 1 (p1) □ position 2 (p2) □ position 3 (p3) □ and so forth. In FIG. 18, positions p1, p10, p20, p30, p40, and p50 are labeled, and thus in this particular example, there are 52 positions that are shown as being scanned sequentially from left to right. In FIG. 5, for example, positions 1-66 are labeled, and thus in this particular example, there are 66 positions that are shown as being scanned sequentially from left to right. Scanning can likewise occur with this protocol from right to left, front to back, back to front, etc., depending on the orientation of the equipment and the goals associated with the sequential scanning.

With sequential scanning, in some examples, multiple data sets can be scanned to generate different curve profiles. For example, in FIG. 19, a first data set (200 Reference curves) is shown as being scanned over 166 milliseconds (at 1 frame per msec) from left to right numbered in sequential order from Reference 1 on the left to Reference 200 on the right. In this example, a second data set resulting in 200 ROI curves is shown as being scanned in the same left to right sequential order over 166 milliseconds (at 1 frame per msec). The ROI curves are numbered in reverse sequential order, or from ROI 1 on the right to ROI 200 on the left. The 166 frame scan occurs over a resonance dynamic range (or angular range) of 0° to 3° or 0 RU to 30,000 RU. The ROI resonance dataset or curve generated therefrom can be compared against the reference resonance dataset (or curve) to see the impact of referenced RU RMS noise as a function of curve spacing, where ROI 1 on the right and Reference 1 on the left represent a positive 20,000 RU spacing. Reference curve 100 and ROI curve 100 are roughly in the middle of the scan and create a near 0 offset between the Reference and ROI curve positions. Reference curve 200 on the far right and ROI curve 200 on the far left represent a −20,000 RU spacing, which would result in an uncommon scenario in a typical SPR experiment, but nevertheless illustrates a possible scenario with the highest realm of possibilities for this example being portrayed by using any of the 200 Reference curves as a reference against any of the 200 ROI curves resulting in 4,000 possible pairings.

FIG. 19 suggests that the reference data point on the right can be subtracted from a reference data point on the left to illustrate variations in spacing between the reference and ROI curve. This can be used to compile a negative angular shift, approximate overlay, and positive angular shift between the curves. This can also highlight differences in curve shapes which might couple noise structures differently. Though this particular graph shows scanning from left to right and right to left for the reference scan and the ROI scan, it can likewise occur with both scanning in the same direction and then graphed in opposing directions as shown. Either way, in this example, about 200 ROI curves and 200 Reference curves, the ROI position minus the Reference position can span from about −2 degrees through 0 to +2 degrees.

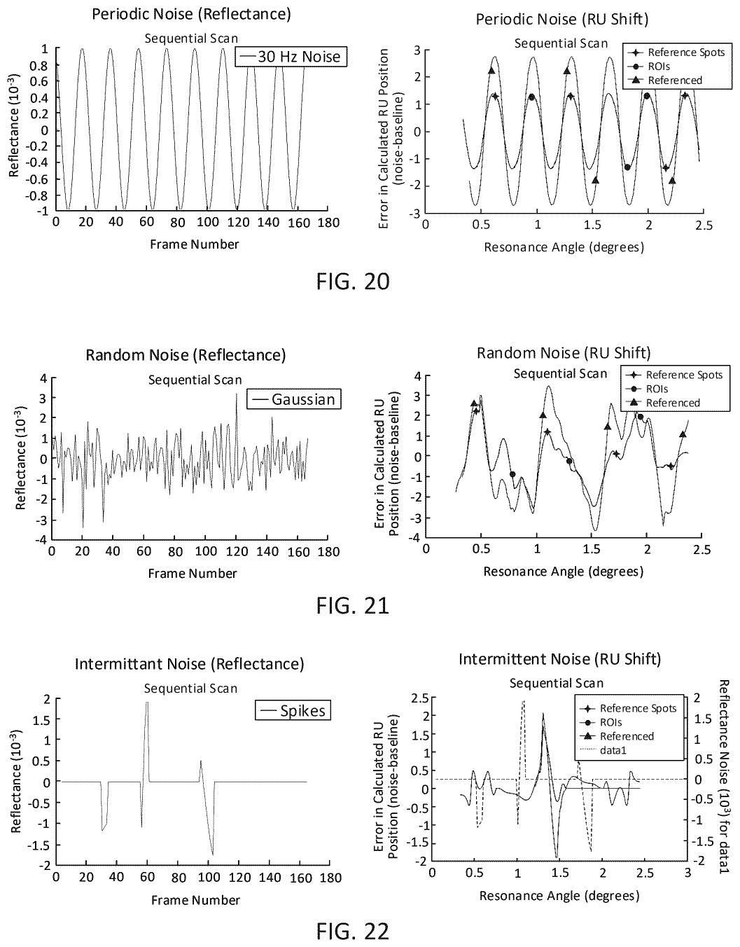

These two data sets can be used to characterize the curve fitting resolution, accuracy, and precision by comparing the noise impact on the resulting response unit (RU) angle or resonance unit angle calculations (defined as angle where the SPR curve reaches its minimum). FIGS. 20-22 illustrate examples of this process, including graphs for periodic noise, random noise, and intermittent noise, respectively (graph on the left). Essentially, by taking all of these curves, noise can be added and then the response unit angle (RU) or resonance unit angle can be calculated. By comparing the resonance angles with noise and without noise, the RU shift can be calculated as the delta or difference between those two curves, as illustrated in Formula II, as follows:

$$RU Noise Curve - Original RU Curve = RU Shift \qquad Formula II$$

Thus, the original curve with noise added versus the original curve with no noise added can be used to determine how much the noise caused the RU to change. The RU Shift thus relates to the noise that caused the resulting RU calculation to shift (+/−) in varying degrees. The resulting RU Shift (or RU error) calculations with regard to each SPR curve angular position are illustrated in FIGS. 20-22 related to “RU Shift” (the graphs on the right) and show the impact of these three types of noise as it relates to RU shift. In these graphs, ROI spots and reference regions are plotted relative to their calculated Resonance Angle. The Referenced data line is plotted per the original ROI position and the original Reference position is ignored (recall the ROI curves are numbered right to left and the Reference curves are numbered left to right). From this it can be seen that Reference and ROI positions that occupy the same angular position correlate well with each other, but when ROI spots are referenced with a reference region that occupies a different angular position the Referenced RU RMS error can become uncorrelated and result in an increase of the referenced RU RMS noise. For this reason, it is generally beneficial to have the absolute positions of the Reference and ROI SPR curves as close to each other as possible. This can be achieved by depositing minimal ligand and analyte on a surface, but this can restrict the dynamic range (or angular range) of signal that can be detected.

As can also be seen in FIGS. 12-14, the RU shift after a sequential scan ranges from about +/−3 RU for a reflectance noise less than about +/−0.4% (where reflectance 1=100%), which indicates that any resonance generated from a sample at an ROI would need to indicate a resonance above about 5 RU in order to provide valuable information that is outside of the noise profile. Resonance values to be reliably detected and used in sample evaluation should typically be about 2 times the level of any noise that may be present in the system.

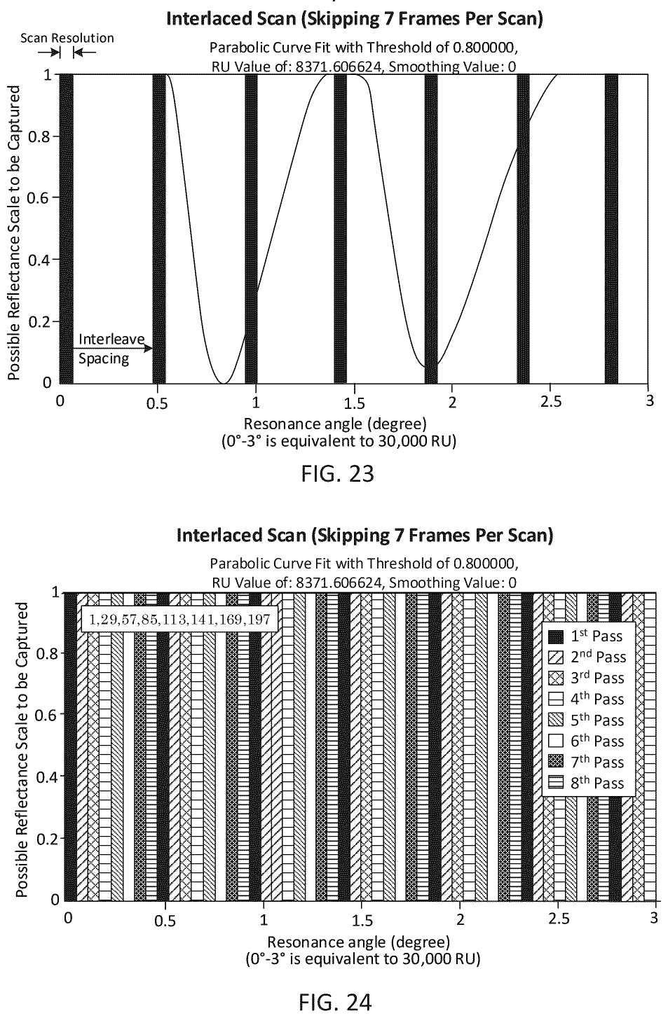

Conversely, referring now to FIGS. 23-24, schematic graphs are shown that illustrate an example of non-sequentially scanning, namely interlace scanning. In this example, the bars shown at various resonance angles graphically illustrate eight (8) passes, where seven (7) resonance angle positions or frames are skipped for each pass. Thus, on the first pass, the interlace scan captures the image(s) at about 0° and then using the optical deflector to skip seven of the incremental angles, the next images or frames captured are found at about 0.5° (relative to the initial scan at about 0°), and so forth along the entire 0° to 3° angular range. If each frame captured takes about 1 millisecond as an example, then the entire angular range can be partially scanned within about 7 milliseconds, which is much quicker than the 50 milliseconds it would take to scan the entire angular range sequentially. Thus, during the first pass, partial resonance data can be collected from both the reference resonance curve and the ROI resonance curve, even if they are separated without any temporal overlap, such as that shown in FIG. 10. The second pass would follow the first pass using the same resonance angle skipping but starting just to the right of the first pass, and so forth. Thus, during each pass, partial information may be captured for one or both (or none, depending on where the curves fall) of the resonance curves, e.g., the reference resonance curve and the ROI resonance curve. After collecting all of this data, the eight (8) interlace scans can then be recombined or reassembled in the correct order to reveal both the reference SPR curve and the ROI SPR curve.

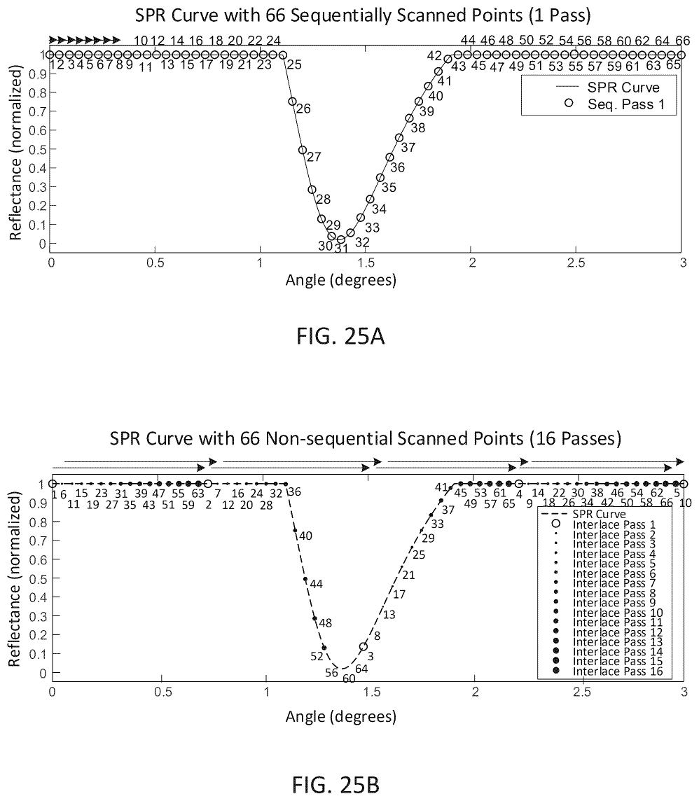

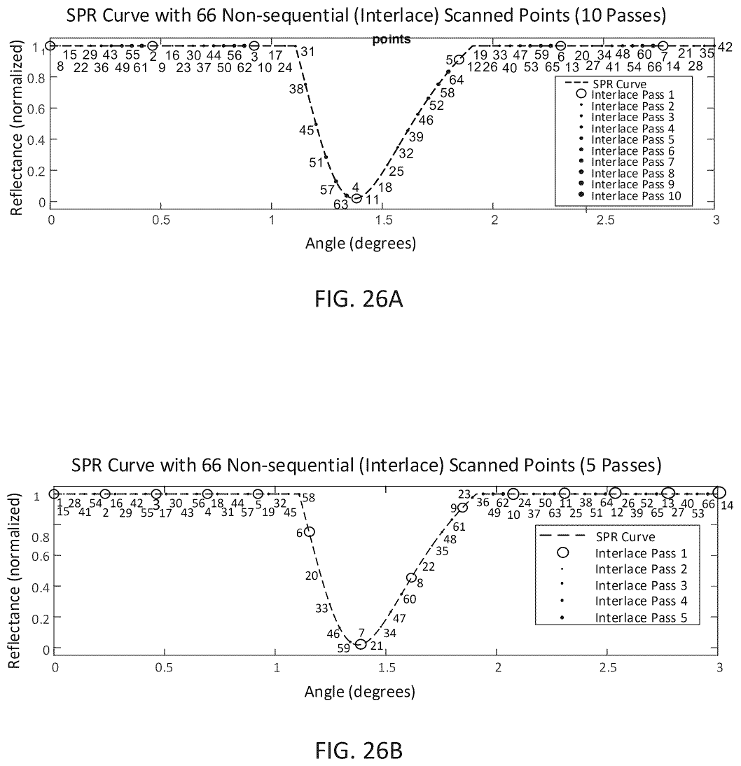

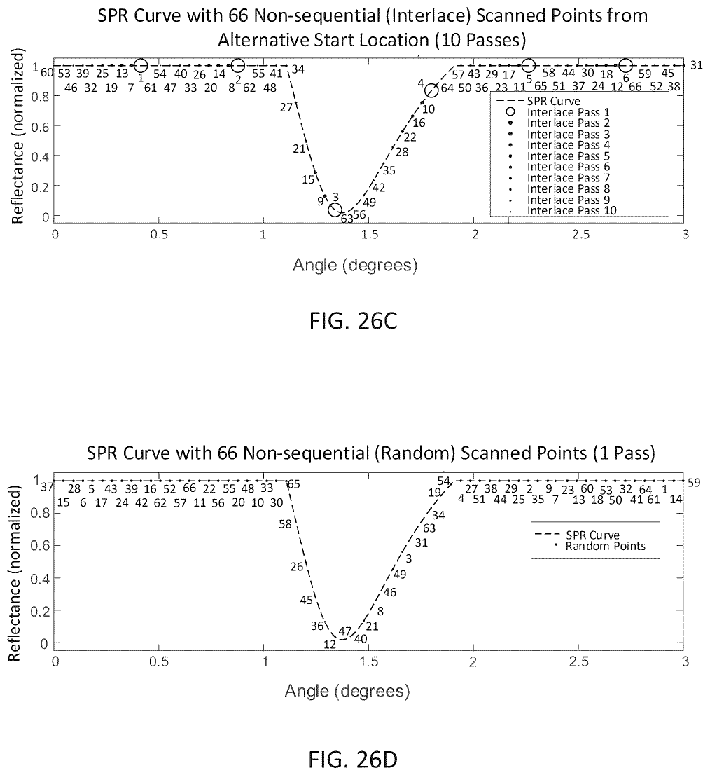

FIGS. 25A-25B and 26A-26D illustrative examples of interlace scanning routines, including but not limited to interlace scanning with different skipping numbers, reverse order, or randomly selected positions. Notably, FIG. 25A utilizes the same data as shown in FIG. 5, but includes additional details regarding number of passes, i.e. 1 pass, and direction of the pass. Other scan order permutations could be included in the context of interlace scanning, so long as a full scan of the dynamic range is collected (and mapped in some examples) in a non-sequential pattern within the dynamic range, resulting in a non-sequential timing correlation. Referring specifically FIG. 25B, here the representative SPR curve is shown 16 passes of interlace scanning are overlain with each frame position indicated by a marker of dots or open circles. The first scan is illustrated by a large open circle to readily direct the eye to the 1^{st} scan and the number of skipped frames. Subsequent passes are illustrated with marker dots of increasing size from scan 2 to scan 16. The capture sequence of each frame throughout the scan is indicated by the numbering below each marker. It can be clearly seen that multiple passes of slightly shifted angular positions are collected then reassembled sequentially into a single scan to create a complete SPR curve of the desired number of frames for optimal scan resolution. The density or spacing of each frame within the scan need not be identical, it could change throughout the scan, frame to frame, or scan to scan. It could also be changed in real-time based on knowledge of previous scans to adaptively capture a higher density of frames within certain regions of the dynamic range and spend less time in regions where there is no meaningful information to be collected. One could also employ artificial intelligence (AI) to monitor and adjust settings to avoid problematic instrument noise structures and minimize system level noise.

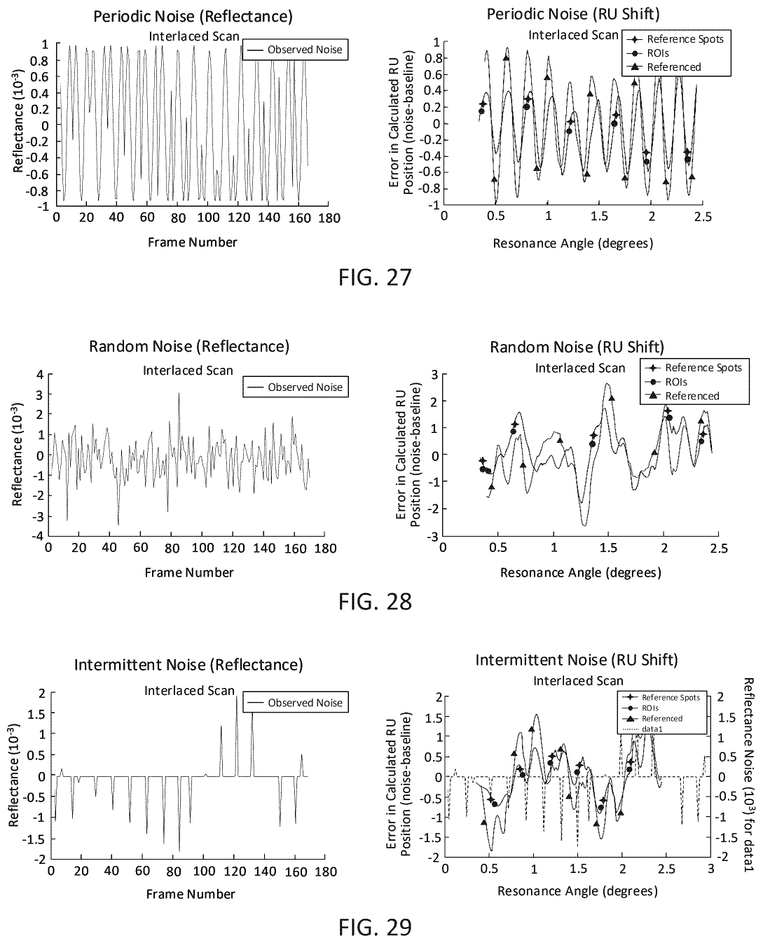

FIGS. 27-29 each show two graphs, similar to that shown in FIGS. 20-22, but in this instance, rather than the frames and resonance angle data being collected and calculated for response unit (or resonance unit) angle shift (RU shift) using sequential scanning, similar data is shown as a result of interlace scanning. The same processes as described with respect to FIGS. 20-22 for generating the RU shift curves can be used in generating the RU shift data for the interlace scans. As can be seen in FIGS. 16-18, the RU shift generated by this process after interlace scanning ranges from about +/−1 RU for the periodic noise, about +/−3 RU for the random noise, and about +/−2 RU for the intermittent noise. Notably, the graphs shown in FIGS. 27-29 use the same noise structure as those shown in FIGS. 20-22, but after re-distributing the noise via interlace scanning, a change in structure exists and consequently a different resulting RU calculation.

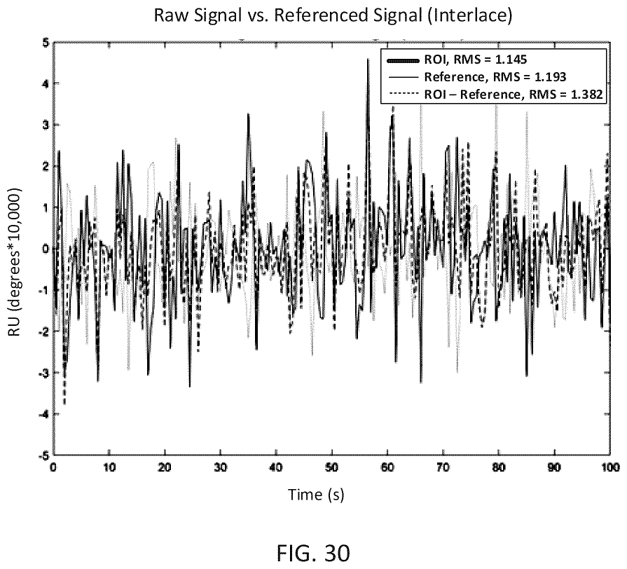

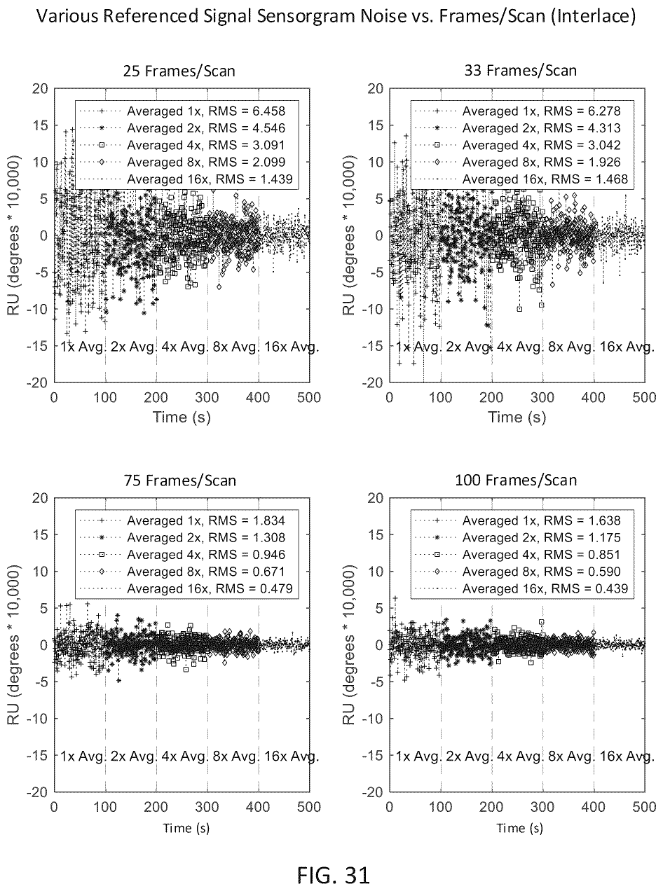

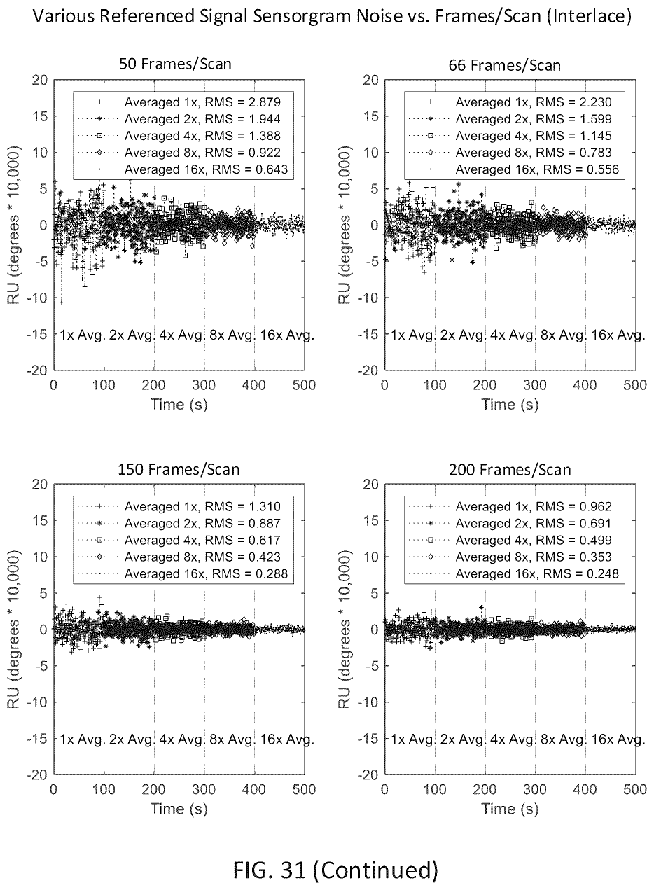

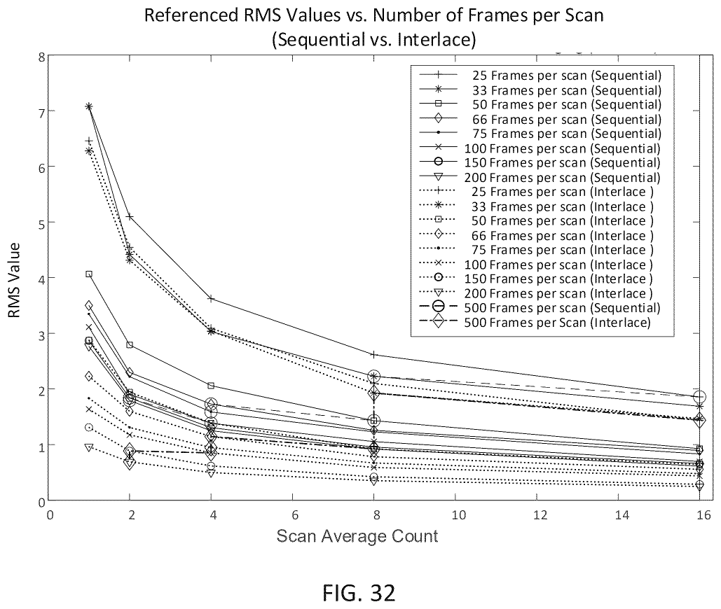

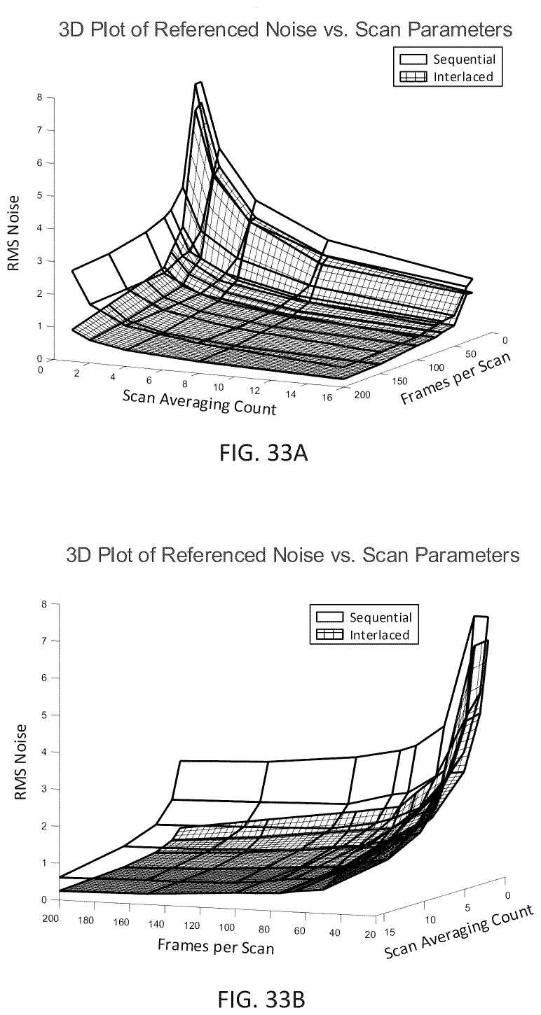

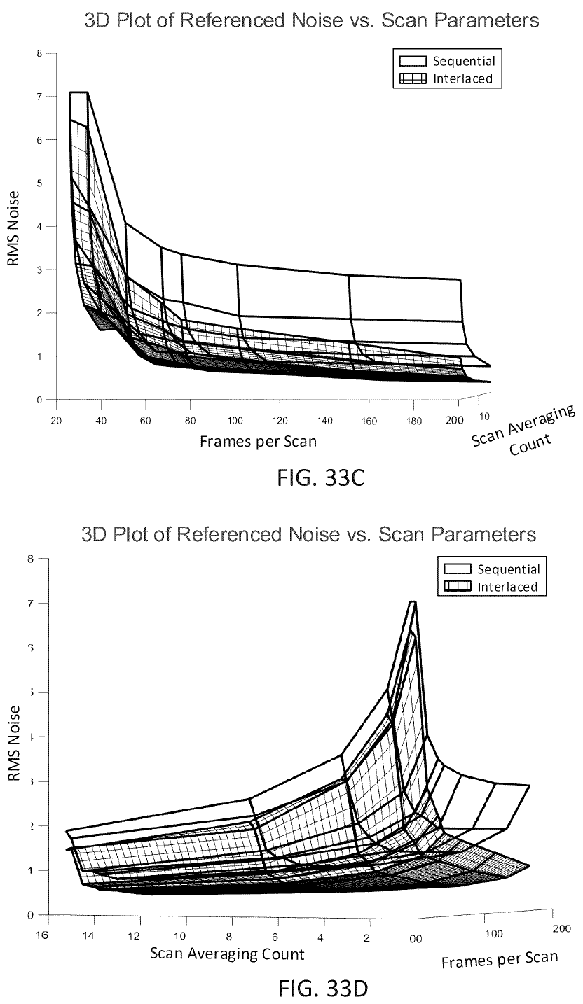

Referring now to FIGS. 30, 31, 32, and 33A-33D, each graph is similar to those shown at FIGS. 11-14, but in this instance, rather than the frames and resonance angle data being collected and calculated for response unit (or resonance unit) using sequential scanning, this data shown is a result of interlace scanning. The same processes as described with respect to FIGS. 30-33D for generating referenced values is used, comparing sensorgrams of various frames per scan and averaging values, and 2D and 3D comparisons of RMS noise can be used in generating the data for the interlace scans. Interlace scanning was shown to perform better with every combination. Referenced signal RMS can increase, but with non-sequential scanning, it does not increase as much.

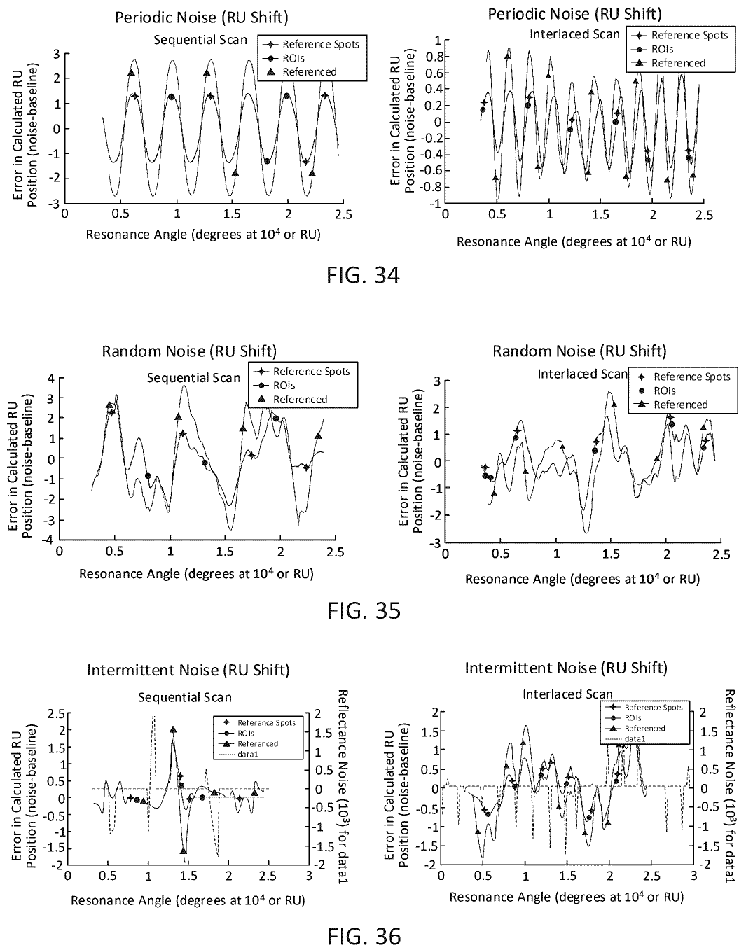

Referring now to FIGS. 34-36, the various types of noises and the RU shift resulting therefrom are directly compared with respect to sequential scanning (FIGS. 20-22) and interlace scanning (FIGS. 27-29).

As can be seen in FIG. 34, a direct comparison of the resonance shift from periodic noise resulting from sequential scanning versus interlace scanning indicates about a 3-fold reduction in RU shift. Thus, rather than having an error in calculated RU position of about +/−3 resulting from sequential scanning, an error in calculated RU position of about +/−1 resulting from interlace scanning is realized. If the goal is to measure resonance at the ROI with at least 2× the level of noise, interlace scanning may be able to measure resonance at sensitivity levels about 3 times that of sequential scanning, e.g., about 2 RU (interlace) versus about 5-6 RU (sequential), with respect to sensitivity over periodic noise.

FIG. 35 shows a direct comparison of the resonance shift from random noise resulting from sequential scanning versus interlace scanning, with minor improvement in RU shift when using interlace scanning. As random noise (Gaussian noise) is not predictable by its nature, this was not expected to provide improvement, and thus it was surprising that there was a marginal improvement via interlace scanning.

FIG. 36 shows a direct comparison of the resonance shift from intermittent noise resulting from sequential scanning versus interlace scanning indicating a moderate improvement when using interlace scanning. Thus, rather than having an error in calculated RU position of about +/−2 resulting from sequential scanning, an error in calculated RU position of about +1.5/−1.8 resulting from interlace scanning is realized. If the goal is to measure resonance at the ROI with at least 2× the level of noise, interlace scanning may be able to measure resonance at sensitivity levels about 25% improved compared to sequential scanning over intermittent noise.

In particular regarding FIGS. 30-32, with regard to periodic noise (which is more frequency dependent), moving from sequential scanning to interlace scanning generated a considerable improvement. With random (Gaussian) noise, moving from sequential scanning to interlace scanning generated a more comparable result. With intermittent noise (which is more duration dependent), moving from sequential scanning to interlace scanning generated a modest improvement in noise reduction. In further detail, the use of interlaced scanning can have the effect of causing periodic noise and intermittent noise to appear or act more like random noise. Again, it is noted that resonance signals can vary over time during an SPR reaction due to factors not related to the small molecule interactions that may be occurring at the application surface. Sources of this variance can include thermal drift, fluid flow differences, refractive index changes, etc., such as those described previously. This is why a reference region is used (often in close proximity to the ROI). However, when using a reference region to remove unwanted noise, though unwanted signal variation that correlates with the ROI gets removed, uncorrelated noise tends to get amplified. As such, in many cases, referenced RMS noise is usually greater than the raw noise of the individual ROI and reference region. Interlace scanning at the time of data capture can reduce this unwanted noise, including uncorrelated noise.

Though FIGS. 30-32 focused on three different types of noise, it can often be useful to correlate the various noises as “RMS noise,” which refers to the root mean square of the noise, or the average noise. As an example, RMS noise can be used to generate noise curves based on averages, with the squaring function used to get rid of the negative values. The squared values can be added together and the square root of the sum can be divided by the number values used in the calculation. The average value used to generate noise curves refers to the root mean square (RMS) deviation of the noise, or the “RMS noise” value. This mathematical averaging is useful in comparing the total noise profile when comparing noise curves obtained at multiple frequencies (Hz).

Referring now to FIG. 37, as a comparative illustrating the RMS noise of a sensorgram, a data set was generated based on SPR data collected at a region of interest (ROI) at various relative (angular) distances at several frequencies ranging from 0 Hz to 20000 Hz. This FIG. shows the results obtained by sequential scanning. The data collected and illustrated in FIG. 37 shows that many resonance responses to the frequencies applied (with even minimal separation between the ROI and the reference region) generated a minimum RMS noise greater than about 1.6 RU, with 11 Hz generating a curve peak at about 5 RU, 15 Hz generating a curve peak at about 5.5 RU, 6 Hz generating a curve peak at about 3.3 RU, and 30 Hz generating curve peaks ranging from about 3.3 Hz to about 3.6. The other frequencies generated peaks up to about 2.5 Hz (or less). Notably, these four frequencies relate to background time-varying noise that can occur during the SPR curve resonance scan, which causes signal variation from one data point to the next in the sensorgram.

Conversely, FIG. 38 illustrates similar data collected (relative to FIG. 37, but instead of sequential scanning, interlace scanning strategy was employed to collect the data). Again, this relates to the RMS noise of a sensorgram. The data collected and illustrated in FIG. 38 shows that many resonance responses to the frequencies applied (with even minimal separation between the ROI and the reference region) generated a minimum RMS noise greater than about 1.3 RU (which provides some improvement over sequential scanning). However, an even more significant improvement was noted with respect to the curve peaks generated at all frequencies. Notably, the four largest curve peaks from sequential scanning, namely 6 Hz, 11 Hz, 16 Hz, and 30 Hz, were all considerably reduced, with 6 Hz generating a curve peak at about 2 RU (˜1.3 RU improvement), 11 Hz generating a curve peak at about 1.7 RU (˜3.2 RU improvement), 15 Hz generating a curve peak at about 1.8 RU (˜3.7 RU improvement), and 30 Hz generating curve peaks ranging from about 2.2 Hz (1.1 RU improvement). The other frequencies generated peaks less than about 2 RU, which on average is about a 0.5 RU improvement. Thus, with all other things being equal, interlace scanning and reassembly of the curve sequentially provides a considerable improvement in RMS noise reduction compared to more conventional sequential scanning approaches.

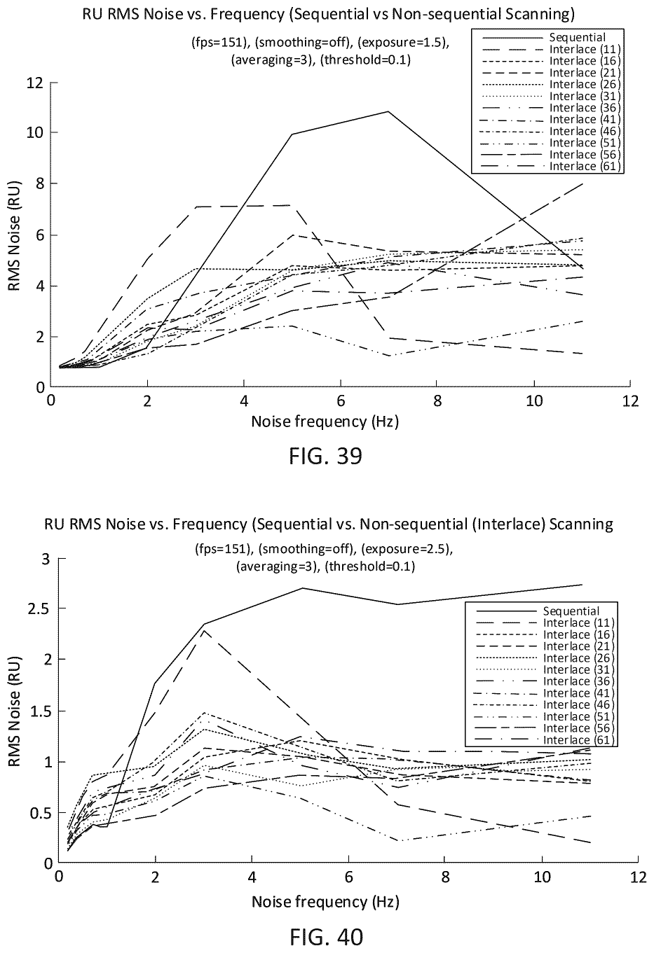

FIGS. 39-41 illustrate an alternative variable that can be considered in reducing RMS noise (in addition to interlace scanning). In this example, various patterns of interlace scanning distances are explored, with interlace scanning passes designed to skip a certain number of resonance angle positions (or frames) ranging from 11 frames to 61 frames per sweep. For comparison, a sequential scan was also conducted (meaning 0 resonance angle positions or frames were skipped). Several frequencies were evaluated for each of these scanning patterns which ranged from about 0 Hz to about 11 Hz. The settings used in FIG. 39 and FIG. 40 were identical except that the exposure was set to 1.5 for the data collected and shown in FIG. 39 and the exposure was set to 2.5 for the data collected and shown in FIG. 40. The overall effect of changing the exposure is that the reflectance SPR curve vertical axis is stretched and moved upwards slightly so the signal saturates earlier. In an SPR optics system, this would be similar to increasing the optical power or increasing the camera's gain or exposure value to increase stretch the vertical axis as a ratio of 2.5/1.5 or 66%. The overall noise at all frequencies was generally lower when the exposure was set at 2.5 instead of 1.5 due to the slope of the curve being steeper relative to angular shift resulting in a higher signal to noise ratio with respect to angular position on the Resonance curve and more symmetric curve shape left and right of the resonance minima (calculated RU position). Exposure values may vary while still operating under the teachings of the present disclosure. Exposure values define how much light can be captured to increase or even maximize the slope of the curve and can be provided by a combination of light illumination and camera exposure. For example. There may be operating limits of saturating the camera or not getting enough contrast and adding more pixel noise, but those can be adjusted as needed when scanning under various circumstances.

As shown more specifically in FIG. 39, the peak RMS noise was about 11 RU when a 7 Hz frequency was present in the signal while using sequential scanning, whereas the interlace scanning pattern generating the greatest noise under the same frequency range and conditions were found when skipping 11 resonance angle positions (from about 3-5 Hz) with an RMS noise value of about 7 RU, as well as when skipping 56 resonance angle positions (from about 10-11 Hz) with an RMS noise value from about 7-8 RU. Thus, in the frequency range from about 4 Hz to about 10 Hz, all of the data collected by interlace scanning (regardless of the number of resonance angles or frames skipped) generated less noise than when collected by sequential scanning. Further, above about 3 Hz, most interlace scanning patterns generated less noise than generated via sequential scanning. For clarification, the x-axis represents the modeled periodic noise added to the system when capturing SPR curves. Each line graph can indicate a different interleave value at those frequencies. This graph illustrates how there can be specific combinations that can amplify or dampen the noise.

As shown in FIG. 40, the RMS noise captured at an exposure setting of 2.5 was considerably better for every curve compared to that captured at an exposure setting of 1.5 as shown in FIG. 39. Though all of the noise profiles for every frequency and every interlace pattern was generally improved, the difference between sequential scanning and interlace scanning (at all interlace patterns) was even more dramatic. For example, the RMS noise peaked about 2.7 RU for 5 Hz noise using sequential scanning, whereas the interlace scanning pattern generating the greatest noise under the same frequency range and conditions were found when skipping 11 resonance angle positions (at about 3 Hz) with an RMS noise value of about 2.3. All of the other interlace patterns (ranging from skipping 16-61 resonance angle positions or frames) along the entire frequency range (from >0 Hz to about 11 Hz) ranged from about 0.2 RU to about 1.5 Hz, with several of the interlace patterns remaining below 1 RU along the entire frequency range. Further, above about 1.5 Hz, all of the interlace scanning patterns generated less noise than generated via sequential scanning. Higher exposure essentially converts the SPR curve from looking like it does in FIG. 3 at 172 or FIG. 17 to more like what is depicted in FIG. 10 with only the bottom portion of the SPR curve detectable below saturation, for example.

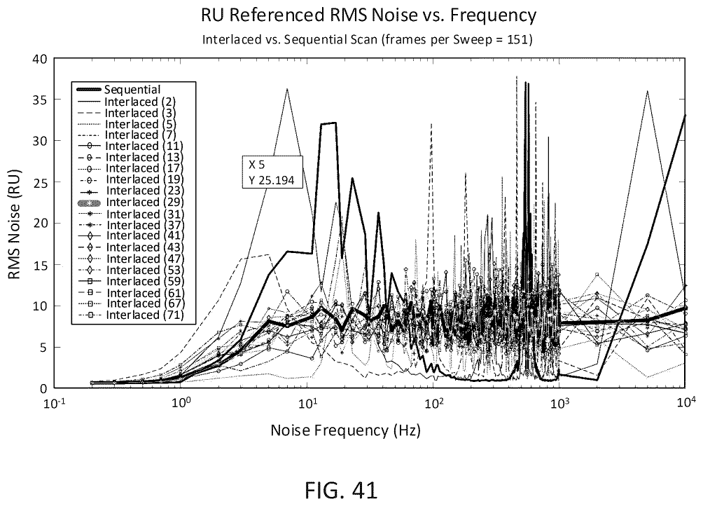

FIG. 41 illustrates a graph with a considerably larger frequency range (from >0 to about 10000 Hz) that evaluated for both a sequential scanning and 20 different interlace scanning profiles (ranging from skipping 2 frames to 71 frames per sweep). Again, the noisiest curve was generated by sequential scanning, with interlace scanning skipping only two resonance angle positions or frames was also poor at about 7 Hz and about 4000 Hz. More improvement in noise reduction occurred when skipping about 7 or more frames, with significant improvement occurring when skipping 11 frames or more. In the example shown, skipping about 29 or so frames per sweep generated an RMS curve above 5 Hz that was relatively tight and consistent, exhibiting noise values ranging from about 5 RU to about 10 RU, which is considerably less than the 33-37 RU peaks that were present when the surfaces were sequentially scanned. As a note, there may be specific frequencies that sequential scanning can be sensitive to. On the other hand, interlace scanning can allow for dampening of problematic frequencies of interest, even if some other frequencies may be amplified as a tradeoff.

The majority of examples described herein were based on the use of an optical angular scanning surface plasmon resonance (SPR) system. It should be noted that the nonsequential scanning (interlaced) technique that is the described herein can be similarly used on any system that uses a signal (optical, electrical, vibrational, or other) to probe a sample and detect an interaction. For example, during operational changes (scans) of one or more aspect of that probe signal, e.g. location, angle, wavelength, polarization, intensity, phase, vibrational frequency, etc., the system can be established to probe a sample that has a region of interest (ROI) or multiple ROIs and/or a reference region or multiple reference regions that can be compared. Furthermore, during operation, the system can detect data from the ROI(s) and/or reference region(s) at different times due to the scanning of the probe signal. Signal scanning can be done in a non-sequential manner (skipping to scan settings and subsequently skipping back to intervening setting values randomly or in a pattern) with the subsequently collected data being then recomposed in a sequential order e.g. incrementally increasing or decreasing changes of the probes signal's variable aspect. Thus, the use of SPR optical scanning technology as described herein is presented for exemplary purposes only to illustrate how any of a number of scanning/sensing technologies can benefit from non-sequential, e.g., interlace, scanning compared to typical sequential scanning.

### Embodiments

In accordance with the disclosure herein, the following examples are illustrative of several embodiments of the present technology.

1. An optical sensing system, comprising:
illuminator optics, including light source, a lens assembly, and an optical deflector capable of modifying an angle of light energy via angle skipping, wherein the illuminator optics are adapted or adaptable to optically scan non-sequential angle positions of a substance or substances carried by a scannable substrate including at a region of interest (ROI), a reference region of scannable substrate, or both; and
imager optics including a detector to receive the light energy after interaction with the ROI, the reference region, or both associated with the scannable substrate.

2. The optical sensing system of example 1, wherein the optical deflector includes an acoustically- or electrically-actuatable deflector.

3. The optical sensing system of one or more of examples 1 or 2, wherein the optical deflector includes an acoustic-optical deflector (AOD).

4. The optical sensing system of one or more of examples 1 or 2, wherein the optical deflector includes an electro-optical deflector (EOD).

5. The optical sensing system of one or more of examples 1 or 2, wherein the optical deflector includes an acousto-optical modulator (AOM).

6. The optical sensing system of one or more of examples 1 to 5, wherein the optical sensing system includes a system selected from surface plasmon resonance (SPR), surface plasmon resonance imaging (SPRi), plasmon-waveguide resonance (PWR), grating-coupled interferometry (GCI), biolayer interferometry (BLI), waveguide interferometry (WI), or a combination thereof.

7. The optical sensing system of one or more of examples 1 to 6, wherein the optical deflector is adjusted using a digital frequency synthesizer to cause the angle shifting of the light energy to occur.

8. The optical sensing system of one or more of examples 1 to 7, further comprising the scannable substrate.

9. The optical sensing system of example 8, wherein the scannable substrate is an application surface suitable for surface plasmon resonance (SPR) or surface plasmon resonance imaging (SPRi), wherein the application surface is adapted to receive substance spots, wherein the application surface is positioned facing a direction opposite an optical interface surface, wherein the optical interface surface is positioned to optically reflect light energy emitted from the illuminator optics in a direction toward the imager optics.

10. The optical sensing system of example 9, wherein the optical interface is semi-transparent, allowing a first portion of the light energy to pass through to the application surface and a second portion of the light energy to be reflected toward the imager optics.

11. The optical sensing system of example 9, wherein the application surface and the optical interface surface are integrated into a sensor chip.

12. The optical sensing system of example 9, wherein the optical interface surface is optically joined or joinable with an internal reflection prism comprising a solid optical material having a high refractive index from about 1.5 to about 1.9 at room temperature.

13. The optical sensing system of one or more of examples 1 to 12, wherein the lens assembly includes a collimating lens assembly positioned to receive light from the light source and collimate the light to be delivered to the optical deflector.

14. The optical sensing system of one or more of examples 1 to 13, wherein the light source is operable to emit wavelengths ranging from about 300 nm to about 1100 nm.

15. The optical sensing system of one or more of examples 1 to 14, wherein the optical deflector is operable to modify the angle of the light energy passing therethrough within an angular range of at least 2.5°.

16. The optical sensing system of one or more of examples 1 to 15, wherein the optical deflector is operable to modify the angle of the light energy passing therethrough within an angular range of at least 3°.

17. The optical sensing system of one or more of examples 1 to 16, wherein the illuminator optics are adapted or adaptable for the angle skipping to generate an interlace scan where at least about 7 angle positions are skipped during at least one sweep.

18. The optical sensing system of one or more of examples 1 to 17, wherein the illuminator optics are adapted or adaptable for the angle skipping to generate an interlace scan where from about 10 to about 100 angle positions are skipped during at least one sweep.

19. The optical sensing system of one or more of examples 1 to 18, wherein the illuminator optics are adapted or adaptable for the angle skipping to generate an interlace scan where individual angle positions are scanned randomly within a predetermined dynamic range.

20. The optical sensing system of one or more of examples 1 to 19, wherein the illuminator optics are adapted or adaptable for the angle skipping to generate an interlace scan where individual angle positions are scanned in a pattern other than that produced by consistent angle position skipping.

21. The optical sensing system of one or more of examples 1 to 20, wherein the illuminator optics are adapted or adaptable to sample a plurality of angle positions within an angular range to locate a portion of the reference curve and a portion of the ROI curve.

22. The optical sensing system of example 21, wherein the illuminator optics are adapted or adaptable to scan one or more narrower angular ranges within a full angular range available for scanning.

23. The optical sensing system of one or more of examples 1 to 22, wherein the illuminator optics include an illuminator telescope to provide anamorphic magnification to reshape light energy from the emitter across an internal reflection prism; reduced keystone distortion of light energy introduced by imager optics and an orientation of the imager adapted to receive light after electromagnetic interaction with the ROI, the reference region, or both along the scannable substrate; or a combination thereof.

24. The optical sensing system of one or more of examples 1 to 23, wherein the detector is a complementary metal-oxide semiconductor (CMOS) detector or a charge coupled device (CCD) detector.

25. A method of scanning a substance carried by a scannable substrate, comprising:
non-sequentially scanning a scannable substrate, the scannable substrate including:
   a region of interest associated with a substance, and
   a reference region not associated with the substance, wherein non-sequentially scanning includes capturing multiple discontinuous data points in sequential time; and
reassembling the multiple discontinuous data points in sequential position order to generate an ROI dataset and a reference dataset.

26. The method of example 25, wherein the ROI dataset and the reference dataset are used to generate an ROI curve, a reference curve, or both.

27. The method of one or more of examples 25 or 26, wherein non-sequentially scanning includes non-sequentially optically scanning frames using a camera at discontinuous locations, and wherein the discontinuous locations are scanned using discontinuous angle positions of an optical scanner within an angular range.

28. The method of example 27, wherein the discontinuous locations are scanned by angle skipping from 1 to about 100 angle positions.

29. The method of example 27, wherein the discontinuous angle positions are scanned by angle skipping from about 7 to about 75 angle positions.

30. The method of example 27, wherein reassembling the multiple discontinuous data points results in a scan of the scannable substrate that accommodates a dynamic range of angles of at least about 0.5°.

31. The method of example 27, wherein reassembling the multiple discontinuous data points results in a scan of the scannable substrate having a dynamic range of angles from about 2° to about 4°

32. The method of one or more of examples 25 to 31, wherein the scannable substrate includes from about 1 to about 4096 regions of interest with corresponding substances spots, and from 1 to about 4096 reference regions.

33. The method of one or more of examples 25 to 32, wherein non-sequentially scanning includes interlace scanning and reassembling results in multiple ROI dataset and at least one reference dataset.

34. The method of one or more of examples 25 to 33, wherein a ratio of reference datasets to ROI datasets generated at a single scannable substrate is from about 1:1 to about 1:4096.

35. The method of one or more of examples 25 to 34, wherein a ratio of reference datasets to ROI datasets generated at a single scannable substrate is from about 1:8 to about 1:4096.

36. The method of one or more of examples 25 to 35, wherein a ratio of reference datasets to ROI datasets generated at a single scannable substrate is from about 1:4 to about 1:64.

37. The method of one or more of examples 25 to 36, wherein a ratio of reference datasets to ROI datasets generated at a single scannable substrate is from about 2:1 to about 16:1.

38. The method of one or more of examples 25 to 37, wherein a ratio of reference datasets to ROI datasets generated at a single scannable substrate is from about 2:1 to about 8:1.

39. The method of one or more of examples 25 to 38, wherein multiple reference datasets are averaged to generate an average reference dataset.

40. The method of one or more of examples 25 to 39, further comprising subtracting noise indicated at the reference dataset from ROI dataset.

41. The method of example 40, wherein subtracting noise includes subtracting periodic noise from the ROI dataset using the reference dataset.

42. The method of example 40, wherein subtracting noise includes subtracting intermittent noise from the ROI dataset using the reference dataset.

43. The method of one or more of examples 25 to 42, wherein non-sequentially scanning includes interlace scanning and reassembling the multiple discontinuous data points results in a noise level that is at least twice as low as compared to sequential scanning using otherwise the same scanning settings and timeframes.

44. The method of one or more of examples 25 to 43, wherein the scannable substrate includes an application surface.

45. The method of example 44, wherein the method further comprises depositing the substance as one or more substance spots on the application surface using a microfluidic flow cell array.

46. The method of example 44, wherein the application surface is included as part of a surface plasmon resonance system.

47. The method of one or more of examples 25 to 46, wherein capturing multiple discontinuous data points includes capturing individual data points within a time frame from about 0.1 millisecond to about 3 milliseconds.

48. The method of one or more of examples 25 to 47, wherein capturing multiple discontinuous data points includes capturing individual data points within a time frame from about 0.2 millisecond to about 2 milliseconds.

49. The method of one or more of examples 25 to 48, wherein the discontinuous locations are separated by from about 100 RU to about 15,000 RU

50. The method of one or more of examples 25 to 49, wherein the discontinuous locations are separated by from about 1,000 RU to about 5,000 RU

51. The method of example 27, wherein non-sequentially scanning includes interlace scanning includes carrying out from about 2 to about 10,000 interlace scanning sweeps to capture all locations within a predetermined dynamic range of locations for reassembling all data points within the predetermined dynamic range.

52. The method of example 27, wherein the discontinuous locations are generated by scanning individual angle positions randomly within the angular range.

53. The method of example 27, wherein the discontinuous locations are generated by scanning individual angle positions with consistently spaced angle positions.

54. The method of example 27, wherein the discontinuous locations are generated by scanning individual angle positions with inconsistently spaced angle positions.

55. The method of example 27, wherein the discontinuous locations are generated by scanning individual angle positions in a pattern other than that produced by consistently spaced angle position skipping.

56. The method of example 27, wherein non-sequentially scanning includes interlace scanning, and the interlace scanning includes:
sampling discrete regions within the angular range to locate the reference dataset and the ROI dataset; and
scanning at angles to capture the reference dataset and the ROI dataset without scanning the angular range in full that is available for scanning.

57. The method of example 56, wherein scanning the angles also includes interlace scanning by capturing multiple discontinuous data points in sequential time at discontinuous angle positions.

58. The method of example 56, further comprising reassembling the multiple discontinuous data points in sequential angle position order to generate the ROI dataset and the reference dataset.

59. The method of one or more of examples 25 to 58, wherein non-sequentially scanning includes scanning wavelengths to generate data points in sequential time but having non-sequential wavelength values.

60. The method of one or more of examples 25 to 59, wherein non-sequentially scanning is carried out using an optical sensing system for use with a scanning system selected from surface plasmon resonance (SPR), surface plasmon resonance imaging (SPRi), plasmon-waveguide resonance (PWR), grating-coupled interferometry (GCI), biolayer interferometry (BLI), waveguide interferometry (WI), or a combination thereof.

61. The method of one or more of examples 25 to 60, wherein the multiple discontinuous data points captured at discontinuous locations occurs using an optical deflector suitable for angle skipping.

62. The method of example 61, wherein the optical deflector includes an acousto-optical deflector (AOD), an acousto-optical modulator (AOM), or an electro-optical deflector (EOD).

63. The method of example 61, comprising adjusting a digital frequency synthesizer to generate the angle skipping.

64. The method of example 25, wherein non-sequentially scanning includes interlace scanning with multiple scanning passes, wherein the multiple scanning passes utilizes a fixed number of skipped data points that is uniform for the multiple scanning passes.

65. A flow cell optical sensing system, comprising:
a sensor chip including:
   an application surface adapted to receive a plurality of substance spots at multiple regions of interest (ROI) while leaving multiple reference regions devoid of substance spots for referencing, and
   an optical interface surface positioned facing a direction opposite the application surface;
a microfluidic flow cell array including multiple flow cells to deposit multiple substance spots on the application surface;
illuminator optics, including light source, a lens assembly, and an optical deflector capable of modifying an angle of light energy via angle skipping, wherein the illuminator optics are adapted or adaptable to direct light energy toward the optical interface surface at non-sequential resonance angle positions to generate resonance along the application surface; and
imager optics including a detector to receive the light energy after reflection from the optical interface and electromagnetic interaction with the application surface at the ROI and the reference region.

66. The flow cell optical sensing system of example 65, wherein the optical deflector includes an acoustically-actuatable deflector or an electrically-actuatable deflector.

67. The flow cell optical sensing system of example 65, wherein the optical deflector includes an acousto-optical deflector or an electro-optical deflector.

68. The flow cell optical sensing system of one of examples 65 to 67, wherein the optical deflector is adjusted using a digital frequency synthesizer to cause the angle shifting of the light energy to occur.

69. The flow cell optical sensing system of one of examples 65 to 68, further comprising the application surface.

70. The flow cell optical sensing system of example 69, wherein the application surface is part of a surface plasmon resonance (SPR) assembly or a surface plasmon resonance imaging system (SPRi), wherein the application surface is adapted to receive substance spots, wherein the application surface is positioned facing a direction opposite an optical interface surface, wherein the optical interface surface is positioned to optically reflect light energy emitted from the illuminator optics in a direction toward the imager optics.

71. The flow cell optical sensing system of example 70, wherein the optical interface is semi-transparent, allowing a first portion of the light energy to pass through to the application surface and a second portion of the light energy to be reflected toward the imager optics.

72. The flow cell optical sensing system of example 70, wherein the application surface and the optical interface surface are integrated into a sensor chip.

73. The flow cell optical sensing system of example 70, wherein the optical interface surface is optically joined or joinable with an internal reflection prism comprising a solid optical material having a high refractive index from about 1.5 to about 1.9 at room temperature.

74. The flow cell optical sensing system of one of examples 65 to 73, wherein the lens assembly includes a collimating lens assembly positioned to receive light from the light source and collimate the light to be delivered to the optical deflector.

75. The flow cell optical sensing system of one of examples 65 to 74, wherein the light source is operable to emit wavelengths ranging from about 300 nm to about 1100 nm.

76. The flow cell optical sensing system of one of examples 65 to 75, wherein the optical deflector is operable to modify the angle of the light energy passing therethrough within a range of at least 2.5°.

77. The flow cell optical sensing system of one of examples 65 to 76, wherein the optical deflector is operable to modify the angle of the light energy passing therethrough within a range of at least 3°.

78. The flow cell optical sensing system of one of examples 65 to 77, wherein the illuminator optics are adapted or adaptable for the angle skipping to generate an interlace scan where at least about 7 resonance angle positions are skipped during at least one sweep.

79. The flow cell optical sensing system of one of examples 65 to 78, wherein the illuminator optics are adapted or adaptable for the angle skipping to generate an interlace scan where from about 10 to about 100 resonance angle positions are skipped during at least one sweep.

80. The flow cell optical sensing system of one of examples 65 to 79, wherein the illuminator optics are adapted or adaptable for the angle skipping to generate an interlace scan where individual resonance angle positions are scanned randomly within a predetermined angular range.

81. The flow cell optical sensing system of one of examples 65 to 80, wherein the illuminator optics are adapted or adaptable for the angle skipping to generate an interlace scan where individual resonance angle positions are scanned in a pattern other than that produced by consistent resonance angle position skipping.

82. The flow cell optical sensing system of one of examples 65 to 81, wherein the illuminator optics are adapted or adaptable to sample a plurality of resonance angle positions within an angular range to locate a portion of one or both of the resonance curves associated with the ROI or the reference region.

83. The flow cell optical sensing system of one of examples 65 to 82, wherein when one or both of the resonance curves associated with the ROI or the reference region are located, the illuminator optics are adapted or adaptable to scan one or more narrower angular range(s) via interlace scanning.

84. The flow cell optical sensing system of one of examples 65 to 83, wherein the illuminator optics includes an illuminator telescope to provide anamorphic magnification to reshape light energy from the emitter; reduced keystone distortion of light energy after the electromagnetic interaction with the ROI, the reference region, or both along the application surface; or a combination thereof.

85. The flow cell optical sensing system of one of examples 65 to 84, wherein the detector is a complementary metal-oxide semiconductor (CMOS) detector or a charge coupled device (CCD) detector.

86. The flow cell optical sensing system of one of examples 65 to 85, wherein the microfluidic flow cell array is adapted to insert into a flow cell applicator assembly or a cartridge of a flow cell applicator assembly.

87. The flow cell optical sensing system of one of examples 65 to 86, wherein the microfluidic flow cell array comprises a fluid directing body and an applicator tip.

88. the flow cell optical sensing system of example 87, wherein the fluid directing body and the applicator tip are modularly connectable to form the multiple flow cells.

89. The flow cell optical sensing system of example 87, wherein the fluid directing body and the applicator tip are integrated as a unitary structure.

90. The flow cell optical sensing system of example 87, wherein the applicator tip is of a material that is softer or more flexible than the fluid directing body. are integrated as a unitary structure.

91. The flow cell optical sensing system of example 87, wherein:
the fluid directing body defines a plurality of body microfluidic channels fluidically connecting source fluid openings with distal body openings at a distal body surface, and
the applicator tip includes a proximal tip surface defining proximal tip openings fluidically coupled to corresponding distal tip openings at a distal tip surface, the distal tip openings arranged to provide fluid communication between the applicator tip and an application surface when the distal tip surface is contacted therewith.

92. The flow cell optical sensing system of one of examples 65 to 91, wherein the applicator tip laterally defines a plurality of flow chambers sealable against the application surface, and wherein the fluid directing body is adapted to provide fluid to and from the flow chambers.

93. The flow cell optical sensing system of one of examples 65 to 92, comprising from about 4 to 192 flow cells adapted to deposit one or more substances on the application surface at multiple regions of interest (ROIs) while leaving reference regions without the one or more substances applied to the application surface.

94. The flow cell optical sensing system of one of examples 65 to 93, wherein the applicator tip is integrated with the application surface.

95. The flow cell optical sensing system of one of examples 65 to 94, wherein in addition to a mechanical pressure-induced seal of the applicator tip application surface, the applicator tip also removably connectable with the application surface.

96. A method of preparing and optical resonance scanning an application surface, comprising:
depositing multiple substance spots on an application surface of a sensor chip to generate multiple regions of interest while leaving at least one reference region without application of a substance spot, wherein the depositing is carried out by a microfluidic flow cell array having multiple flow cells, and wherein the sensor chip also includes an optical interface surface positioned facing a direction opposite the application surface;
non-sequentially scanning the substance spots on the application surface by directing light energy toward the optical interface to generate optically detectable resonances at the regions of interest and optically detectable noise resonance at the at least one reference region, wherein non-sequentially scanning includes capturing multiple frames in sequential time at discontinuous resonance angle positions; and
reassembling the multiple frames in sequential resonance angle in position order to generate an ROI resonance curve and a reference resonance curve.

97. The method of example 96, wherein the discontinuous resonance angle positions are scanned by angle skipping from about 7 to about 75 resonance angle positions.

98. The method of one of examples 96 or 97, wherein reassembling the multiple frames results in a scan of the application surface having an angular range of at least 2.5°.

99. The method of one of examples 96 or 98, wherein the application surface includes from about 8 to about 4096 regions of interest with corresponding substances spots, and from 1 to about 4096 reference regions.

100. The method of one of examples 96 or 99, wherein a ratio of reference resonance curves to ROI resonance curves generated at a single application surface is from about 2:1 to about 16:1.

101. The method of one of examples 96 or 100, wherein multiple reference resonance curves are averaged to generate an average reference resonance curve.

102. The method of one of examples 96 or 101, further comprising subtracting noise indicated at the reference resonance curve from ROI resonance curve.

103. The method of one of examples 96 or 102, wherein non-sequentially scanning includes interlace scanning and reassembling results in noise profile that is at least twice as low as compared to sequential scanning using otherwise the same scanning settings and timeframes.

104. The method of one of examples 96 or 103, wherein the sensor chip is included as part of a surface plasmon resonance system.

105. The method of one of examples 96 or 104, wherein capturing multiple frames includes capturing individual frames within a time frame from about 0.1 millisecond to about 3 milliseconds.

106. The method of one of examples 96 or 105, wherein the discontinuous resonance angle positions are separated by from about 500 RU to about 10,000 RU.

107. The method of one of examples 96 or 106, wherein non-sequentially scanning includes interlace scanning and includes carrying out from about 2 to about 1,000 interlace scanning sweeps to capture all resonance angle positions within a predetermined angular range of resonance angles for reassembling all frames within the predetermined angular range.

108. The method of one of examples 96 or 107, wherein the discontinuous resonance angle positions are generated by scanning individual resonance angle positions randomly within a predetermined angular range.

109. The method of one of examples 96 or 108, wherein the discontinuous resonance angle positions are generated by scanning individual resonance angle positions with consistently spaced resonance angle positions.

110. The method of one of examples 96 or 109, wherein the discontinuous resonance angle positions are generated by scanning individual resonance angle positions in a pattern other than that produced by consistently spaced resonance angle position skipping.

111. The method of one of examples 96 or 110, wherein non-sequentially scanning includes interlace scanning, and the method further includes:
sampling discrete regions within an angular range to locate the reference resonance curve and the ROI resonance curve; and
scanning at resonance angles to capture the reference resonance curve and the ROI resonance curve without scanning a full available angular range of angles available for scanning.

112. The method of example 111, wherein scanning the resonance angles also includes interlace scanning by capturing multiple frames in sequential time at discontinuous resonance angle positions.

113. The method of example 112, further comprising reassembling the multiple frames in sequential resonance angle position in order to generate the ROI resonance curve and the reference resonance curve.

114. The method of one of examples 96 or 113, wherein the multiple frames captured at discontinuous resonance angle positions occurs using an optical deflector suitable for resonance angle skipping upon adjusting a digital frequency synthesizer to generate the resonance angle skipping.

115. The method of one of examples 96 or 114, wherein non-sequentially scanning is interlace scanning and is carried out using collimated light at one or more wavelength from about 300 nm to about 1100 nm.

### Definitions

In describing embodiments of the present disclosure, the following terminology will be used. Unless defined otherwise, all technical and scientific terms, terms of art, and acronyms used herein have the meaning commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, certain compositions, methods, articles of manufacture, or other means or materials are described herein.

The singular forms “a,” “an” and “the” include plural referents unless the context clearly dictates otherwise. Thus, for example, reference to “a flow cell includes reference to one or more flow cells.

As used herein, “comprising” or “including” language or other open-ended language can be substituted with “consisting essentially of” and “consisting of” as if such transition phrase is expressly included in such embodiments.

A “microfluidic flow cell array” (MFCA) in some examples can include a fluid directing body joined with an applicator tip, either as a monolithic unitary structure, or a composited device where the two structures are joined together permanently, or a modular structure where the applicator tip can be joined and disjoined from the fluid directing body. Typically, a microfluidic flow cell array includes a plurality of individual flow cells carried at least in part by the same body or bodies, e.g., fluid directing body, applicator tip, etc. There may be other structures included as well, such as a fluid control adapter positioned between the fluid directing body and the applicator tip, for example. In this example, when in use, the fluid directing body is where a user or automation (machine) interfaces with the fluid as it is injected or removed from the fluid directing body, and the applicator tip is the portion that becomes sealed against the application surface to provide fluid flow across the application surface via its flow chamber(s) to carry out any of a number of functions, e.g., depositing substance spots, surface preparation, deposition spot washing, microfluidic channel priming, generating a reaction, removing materials, swapping materials, manipulating cells, or a combination thereof. Multiple flow cells of a microfluidic flow cell array can generate any number of substance spots (or other fluid/application surface interaction) on an application surface via its flow chamber, depending on design, with a few examples including an array of flow chambers at 4×4, 5×5, 6×6, 8×8, 4×8, 1×8, 2×16, 4×24, 8×12, 6×8, 6×16, 8×24, and any other arrangement or any shape of flow chambers that can be fit at a distal tip surface of an applicator tip. The number of flow cells with corresponding flow chambers at a distal tip surface of an applicator tip can be, for example, up to 48, 96, 192, 384, 768, or more, e.g., from 2 to 768 flow cells, from 4 to 192 flow cells, from 8 to 96 flow cells, etc.

A “flow cell” of a microfluidic flow cell array, as an example, can include any structure where a flow path for channeling fluid is associated with a flow chamber for interacting with an application surface. The microfluidic flow cell array defined above typically includes a plurality of individual flow cells within a common unitary or modular structure. Typically, the flow path of an individual flow cell provides ingress of fluid through a first microfluidic flow path to the flow chamber for substance deposition onto an application surface or for some other fluid/application surface interaction, e.g., depositing substance spots, surface preparation, deposition spot washing, microfluidic channel priming, generating a reaction, removing materials, swapping materials, manipulating cells, or a combination thereof. In some examples, a second microfluidic flow path provides egress of the fluid or substances not deposited on the application surface from the flow chamber. In this latter example, fluid can be flowed unidirectionally or even bi-directionally (back and forth) through the flow paths into and out of the flow chamber of the applicator tip. Thus, the fluid contained within or passing through the flow chamber may deposit a substance carried by the fluid on the application surface to which the flow chamber is sealed.

A “flow chamber” of a flow cell is typically in the form of an open cavity of an applicator tip (or applicator tip portion) of a microfluidic flow cell array. For example, an applicator tip can partially define a volume of a flow chamber, with the volume being further defined by the application surface when the applicator tip is sealed against the application surface. In some instances, the flow chamber may act as a deposition chamber, where substances passing therethrough are deposited on the application surface. In other examples the flow channel may act as a washing chamber or a substance removal chamber, and thus, is not always used for substance application to the application surface. In each use scenario, however, fluid is flowed into and out of the flow chamber, and thus, the term “flow chamber” is inclusive of these and other fluid interactions that occur at the application surface, for example. Even in instances where the fluid might temporarily be held stagnant within the flow chamber against the application surface, e.g., soaking the application surface or simply pausing between flows, there would still be fluid flow before or after such a fluid hold within the flow chamber.

“Microfluidic channel(s)” is a term that may be interchangeable with terms such as channels, microchannels, conduits, microconduits, canals, microcanals, tubules, microtubules, tubes, microtubes, or the like. Microfluidic channels can be defined within any of a number of structures in the present disclosure, such as fluid directing bodies, applicator tips, and/or any intervening structures, e.g., fluid control adapters, etc., which can be connected together modularly to form a flow path of a microfluidic flow cell or multiple flow paths of an array of microfluidic flow cell arrays or can be preassembled or formed as a unitary structure, for example. Thus, a “microfluidic flow path” or “flow path” can be found within a single monolithic structure, or a modular structure of multiple bodies joined together, e.g., fluid directing body joined with an applicator tip with microchannels therein aligned for the microfluidic flow path. Furthermore, the microfluidic channels that form the microfluidic flow path in general may be formed on the micro-scale, providing microfluidic pathways (of any cross-sectional shape) which are typically used to guide the substance(s) to and from an application surface via their independently fluidly coupled flow chamber(s), often providing a fluid flow that produces a high surface concentration of a substance at a specific region (or spot) on an application surface. Each deposition region can be individually addressed with its own flow cell, and a (modular) microfluidic flow cell array may be arranged such that a large number of deposition regions may be addressed in parallel. Locations where substances are applied to the application surface at the deposition regions can be referred to herein as regions of interest (ROI) with respect to generating SPR curves, for example.

When referring to the “cross-sectional” shape, size, dimension, area, etc., of a microfluidic channel(s), it is understood that the term “cross-sectional” in this context refers to the plane of the microfluidic channel that is perpendicular to the direction of fluid flow.

A “large flow cell applicator,” “LFC,” or “single large flow cell applicator” is similar to a microfluidic flow cell array, but in accordance with the present disclosure, an LFC has a single flow cell (not multiple flow cells) and is often used to overprint (or over spot) or underprint (or under-spot) on an application surface at the same location as multiple spots applied by a microfluidic flow cell array. The term “large” simply indicates that the flow chamber size of the flow cell is large enough to apply fluid at the same location as a plurality of spots applied using a microfluidic flow cell array.

The term “scannable substrate” refers to any structure that allows for a substance carried thereon or contained therein to be scanned, e.g., optically, vibrationally, electronically, magnetically, etc. The scannable substrate can be, for example, an application surface, e.g., a semi-transparent application surface, an optical fiber, a quartz crystal resonator or microbalance, a wave guide, a plasmon waveguide, small volume container, etc., e.g. using the interlace scanning and reference scanning methodologies and systems described herein. Example technologies that can include these and other types of scannable substrates include surface plasmon resonance (SPR), surface plasmon resonance imaging (SPRi), plasmon-waveguide resonance (PWR), grating-coupled interferometry (GCI), biolayer interferometry (BLI), and/or waveguide interferometry (WI), etc. Regardless of the scanning equipment used, the scannable substrate may be an inert substrate that does not interact with the fluid or substance associated therewith, e.g., substance spots, or scannable substrate may interact with the fluid or substance. In some instances, the scannable substrate may include a coating on the surface that contacts the substance being evaluated. The term “application surface” refers more specifically to any surface or combination of surfaces to which a substance can be applied in accordance with the present technology. For example, an application surface can be a surface configured to receive substance spots from a distal tip surface (forming a contact deposition seal) of a microfluidic flow cell array is pressed to receive a fluid, a fluid substance, or a fluid carrying a substance. The application surface may be suitable for conducting various assays in some examples. It is noted that the term “application” does not indicate that every interaction between a fluid and the application surface results in the application of a substance spot, but rather, can include fluid interactions with the application surface that do not leave a substance behind for evaluation, e.g., application surface preparation, deposition spot washing, microfluidic channel priming, generating a reaction, removing materials, swapping materials, manipulating cells, or a combination thereof. In further detail, the application surface may part of or integrated with a sensor chip, where substances are applied to the application surface, with an opposing side thereof (typically facing the opposite direction) including reflective material that may be reflective or semi-reflective (semi-transparent) to emitted light directed thereto. Examples of such materials can include thin metal film, e.g., silver, gold, etc., metal coupons, gratings, etc. The reflective material may be optically coupled with a solid optical material, such as a high refractive index prism or other suitably shaped optical material. In the context of surface plasmon resonance (SPR), the application surface may be uncoated, or may include a supplemental coating, pre-applied ligands, etc. Typically, when the application surface is coated, it can be coated uniformly in some examples. Thus, the reference regions may include the presence of a coating, referencing the application surface areas where substance spots applied by the flow cells are not present. The application surface may be transparent, translucent, thermally conductive, electrically conductive, insulated, etc.

The term “solid optical material” refers to any solid shape of optical material where light can enter and interact with a deposited sample, directly or indirectly (SPR), e.g., optical prism for beam shaping, or some other beam shaping configuration. In many instances, an optical prism will be described with some specificity. It is noted, however, that the prism can be any shape that is suitable for shaping light energy for use with the sensing substrate in accordance with examples of the present disclosure.

The term “chip” or “sensor chip” refers to a data collection component used for measuring surface interactions of substance spots at regions of interest (ROI) referenced against reference regions, for example. Typically, a sensor chip includes an application surface (coated or uncoated) on one side and an optical interface surface on the other side. The optical interface surface can include, for example, a thin layer(s) of material, such as a metal film, coupon, grating, etc. The sensor chip is often optically coupled with a solid optical material, but the solid optical material is not typically part of the sensor chip (though they can be fused together physically or merely optically coupled). A sensor chip can have other configurations other than a two-sided chip. For clarity, the term “chip” can alternatively refer to a component that uses memory for storing data, and thus can be referred to more specifically as a “data chip,” “memory chip,” or the like.

A “substance” refers to a fluid or a material carried by a fluid that may include particles, molecules, compounds, or other species of materials that are used to conduct experiments on or within a scannable substrate. In the case of SPR, the substance(s), e.g., substance spots, to be sensed can utilize a sensor chip with an optical interface surface on one side that interacts optically with light emitted from a light source with an application surface on the other side that receives the substance(s) for evaluation. In some instances, the substance(s) can be carried by other types of scannable substrates for conducting experiments, e.g., quartz crystal resonator or microbalance, fiber optic tip, waveguide, small volume container, etc. The substance can include an analyte, a particle, a probe, an immobilized ligand, etc., depending on the context. In some instances, substances can be referred to as being applied to the application surface as “substance spots” or as “spots.”

The term “spot” or “substance spot” refers to a sample or multiple samples applied at a discrete location on a scannable substrate, such as an application surface, typically at a region of interest (ROI), to be compared for noise against a reference region where there is not a substance spot applied. The sample(s) can be applied using a fluid sample that dries, or can remain undried, or can be deposited on an application surface as a fluid carried passes thereby. Substance spots may include one substance, or multiple substances that can be evaluated for reaction or interaction with one another, or one or more substance as it interacts with the application surface (coated or uncoated). In some instances, a second sample can be applied to the same location in an overlapping manner. Sometimes spots are applied by the microfluidic flow cell arrays described herein and then other spots or regions of the application surface may be applied adjacently or overlaid (partially or fully) with other “spots” of typically a different sample (different substance, different substance concentration in a fluid sample, different spot size, etc.).

The terms “print,” “printed,” or “printing” can be used synonymously with the terms “deposit,” “deposited,” “depositing,” “apply,” applying,” etc., and is typically used in the context of application of a substance spot(s) onto an application surface via fluid carrier or the flowing of a fluid across an application surface via a flow chamber in contact with the application surface. The fluid itself may be the substance, or the fluid may simply carry the substance as a dissolved or dispersed substance. In addition, “printing” or “depositing” or “applying” a substance to an application surface can include the flow of fluid across an application surface for a reason other than deposition of a substance or substance spot(s) onto the application surface, e.g., application surface preparation, deposition spot washing, microfluidic channel priming, generating a reaction, removing materials, swapping materials, manipulating cells, or a combination thereof. Thus, these terms should be interpreted broadly to include any application or contact of a fluid with an application surface via fluid deposition, e.g., fluid flow into or through a flow chamber, whether the purpose is to leave a substance spot behind or to carry out some other fluid interaction function. In some instances, the terms “apply,” “applied,” or “applying” may be used as well and should be given the same broad interpretation in the context of flow chamber fluid flow.

It is noted that the terms “first,” “second,” and so forth, are used herein and throughout the present disclosure. In some instances, the term “third,” “additional” or “other” may be used to describe flow cells or other structures beyond the first and second arrangements identified. These terms are meant to be relative to one another only in the context in which they are mentioned, and further, do not infer any order of use that any one of these terms should be associated exclusively with a specific component. For example, a first flow cell could be referred to as a second flow cell or vice versa. In some instances, the “first” flow cell may be referred to as simply a “flow cell,” as the term “first” is simply used for clarity when describing the flow cell applicator relative to a second (or third, or fourth, etc.) flow cell. Thus, these may be described as a flow cell and a second flow cell in some instances, which refers to the same two structures unless the context dictates otherwise. As another example, if a first flow cell applies a first group of substance spots, and then applies a second group of substance spots, a second flow cell can apply a third group of substance spots (from a microfluidic flow cell array) or a single spot from a large flow cell (LFC) applicator, and so forth.

The term “sequential” refers to a scanning order arranged or gathered in an ascending or descending order, or as the various scanning order is encountered in its original pattern.

The term “non-sequential” refers to scanning order taken out of order, which may represent patterned scanning, random scanning, or any other scanning where the scanning order is other than sequential.

The term “interlace” refers to one type of non-sequential scanning, and refers patterned scanning where images are gathered non-sequentially, but typically in an ordered pattern by skipping frames on each pass and then typically picking up intervening frames on subsequent passes.

The terms “recomposing” or “recomposition” refer to reordering scanned images that were gathered non-sequentially and reordering them in their sequential arrangement.

The terms “reference” or “referencing” refers to selecting one data stream that is used to subtract signal structure that includes typical signal variability outside of the desired signal to be measured. Referencing could include normalization via division or multiplication, subtraction or addition, condition matching, quantifying property shifts such as phase, frequency, or wavelength, and that data is used to identify signal changes in a region or property of interest. Referencing can be done in real-time or after the fact, can be based on adjusting an input on a control line compared to a signal line, or can be a signal response from a single input. Referencing can also include double referencing and or blanking. Referencing adjustments could be directed by mathematical modeling, field gradients, minimization routines, or linear regression.

The term “curve-fitting” refers to the process of fitting a mathematical model or applying certain terms or conditions to a data set to identify a property of interest. Curve fitting may also refer to applying mathematical routines to interpolate values between discrete data points generated by scanning a signal.

The term “scanning” refers to the process of recording a signal response with respect to a signal input, whether it be monitoring time, measuring with respect to an angular position, voltage supply, electrical power, magnetic field, e.g., NMR detection, optical power, intensity, wavelength, angle, polarization, refractive index, field effects, frequency, phase, interference, spectral analysis, reflectance, transmission, scatter, mechanical vibration, etc. Furthermore, scanning may be carried out on a scannable substrate or may be carried out without regard for any substrate.

The terms “optimization” or “optimizing” refer to using a signal feedback and a defined characteristic to adjust one parameter to achieve a desired response or effect. Optimization could be done by searching a space and selecting the best performing condition. Could be intuited, interpolated, extrapolated, modeled, or measured. Optimization could be done on a modeled system, actual system, beforehand, after the fact, or in real-time.

The term “time domain” refers to temporal analysis of a variable, mathematical function, or concept with respect to time. These could exist as a physical signal, environmental variable, economic parameter, or others.

The term “non-time domain” relates to “time domain” in that while most things are recorded or captured in real time, the time domain is often present in the data collected. However, there are parameters that are of interest outside of the time domain, and significant information can be found by converting from the time domain to another domain of greater interest. A common example is understanding the frequency (reciprocal) domain because it can help to identify specific sources of noise that sum together in the time domain. For purposes of the present disclosure, non-time domain relates to interest in anything that is a quantifiable variable for characterizing small molecule interactions or kinetics and requires a measured parameter to be mapped outside of the time domain. Specific examples include optical, electrical, electromagnetic, magnetic, or other properties that can be broken down into phase, polarization, angle, power, refractive index, wavelength, frequency, impedance, field effect, mass, magnetic field, magnetic susceptibility, nuclear magnetic resonance (NMR), radiofrequency, or others. for example, SPRi is often enhanced by mapping plasmon resonance with respect to optical incidence angle for varying wavelengths, polarization states, or phase and multiple positions can be scanned to identify a maximum or minimum effect to define that as the characteristic behavior that is reported over time to create a sensorgram.

The term “data point(s)” refers to the data collected within a short period of time in generating data curves using the non-sequential, e.g., interlace, scanning described herein. In some instances, the data point(s) are collected using video capture, and thus the data points may be collected as camera “frames.” Thus, when video capture and display are used, data points may be collected as “frames.” In this instance, the terms “data points” and “frames” may be used interchangeably. In instances where data is scanned by other methodologies that do not use a camera or video device, the term “data point” is more typically used.

Numerical data (numbers of elements, amounts, dimensions, etc.) may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 μm” should be interpreted to include not only the explicitly recited values of about 50 μm and 250 μm, but also the individual values and sub-ranges within the indicated range. Thus, included in this numerical range are individual values such as 60, 70, and 80 μm, and sub-ranges such as from 50-100 μm, from 100-200 μm, and from 100-250 μm, etc. This same principle applies to ranges reciting only one numerical value and should apply regardless of the breadth of the range or the characteristics being described.

As used herein, the term “about” or “˜” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about shall expressly include” exactly, consistent with the discussion above regarding ranges and numerical data. For example, the term “about” can refer to the recited number plus or minus 5%, plus or minus 3%, or plus or minus 1%. To illustrate, the term “about” when interpreted as being plus or minus 5% of a numeric range, such as “from about 1 cm to about 2 cm,” would be interpreted as including a range from 9.5 mm to 2.1 cm, from 1.05 cm to 1.9 cm, from 9.5 mm to 1.9 cm, or from 1.05 cm to 2.1 cm. Similar calculations for any of the other individual numerical values or individual parameters of numerical ranges set forth herein can be modified similarly such that the “about” or “˜” modifier fully supports subranges including +/−3% or +/−1% of the numerical value provided.

The term “example(s)” or “embodiment(s),” particularly when followed by a listing of terms or a description of a particular structure, is merely exemplary and illustrative and should not be deemed to be exclusive or comprehensive.

The devices, systems, methods, and/or compositions disclosed herein are not limited to particular methodology, protocols, reagents, etc., because, as the skilled artisan will appreciate, they may vary. Further, the terminology used herein is for the purpose of describing particular embodiments only and is not intended to and does not limit the scope of that which is disclosed or claimed.

1. An optical sensing system, comprising:
illuminator optics, including light source, a lens assembly, and an optical deflector capable of modifying an angle of light energy via angle skipping, wherein the illuminator optics are adapted or adaptable to optically scan non-sequential angle positions of a substance or substances carried by a scannable substrate including at a region of interest (ROI), a reference region of scannable substrate, or both; and
imager optics including a detector to receive the light energy after interaction with the ROI, the reference region, or both associated with the scannable substrate.

2. The optical sensing system of claim 1, wherein the optical deflector includes an acoustically- or electrically-actuatable deflector, an acoustic-optical deflector (AOD), an electro-optical deflector (EOD), or an acousto-optical modulator (AOM).

3-5. (canceled)

6. The optical sensing system of claim 1, wherein the optical sensing system includes a system selected from surface plasmon resonance (SPR), surface plasmon resonance imaging (SPRi), plasmon-waveguide resonance (PWR), grating-coupled interferometry (GCI), biolayer interferometry (BLI), waveguide interferometry (WI), or a combination thereof.

7. (canceled)

8. The optical sensing system of claim 1, further comprising the scannable substrate, wherein the scannable substrate is an application surface suitable for surface plasmon resonance (SPR) or surface plasmon resonance imaging (SPRi), wherein the application surface is adapted to receive substance spots, wherein the application surface is positioned facing a direction opposite an optical interface surface, wherein the optical interface surface is positioned to optically reflect light energy emitted from the illuminator optics in a direction toward the imager optics.

9. (canceled)

10. The optical sensing system of claim 8, wherein;
the optical interface is semi-transparent, allowing a first portion of the light energy to pass through to the application surface and a second portion of the light energy to be reflected toward the imager optics;
the application surface and the optical interface surface are integrated into a sensor chip.
the optical interface surface is optically joined or joinable with an internal reflection prism comprising a solid optical material having a high refractive index from about 1.5 to about 1.9 at room temperature;
the lens assembly includes a collimating lens assembly positioned to receive light from the light source and collimate the light to be delivered to the optical deflector; or
a combination thereof.

11-13. (canceled)

14. The optical sensing system of claim 1, wherein the light source is operable to emit wavelengths ranging from about 300 nm to about 1100 nm.

15. The optical sensing system of claim 1, wherein the optical deflector is operable to modify the angle of the light energy passing therethrough within an angular range of at least 2.5°.

16. (canceled)

17. The optical sensing system of claim 1, wherein the illuminator optics are adapted or adaptable for the angle skipping to generate an interlace scan where at least about 7 angle positions to about 100 angle positions are skipped during at least one sweep.

18. (canceled)

19. The optical sensing system of claim 1, wherein;
the illuminator optics are adapted or adaptable for the angle skipping to generate an interlace scan where individual angle positions are scanned randomly within a predetermined dynamic range or in a pattern other than that produced by consistent angle position skipping.

20-24. (canceled)

25. A method of scanning a substance carried by a scannable substrate, comprising:
non-sequentially scanning a scannable substrate, the scannable substrate including:
a region of interest associated with a substance, and
a reference region not associated with the substance,
wherein non-sequentially scanning includes capturing multiple discontinuous data points in sequential time; and
reassembling the multiple discontinuous data points in sequential position order to generate an ROI dataset and a reference dataset.

26. The method of claim 25, wherein the ROI dataset and the reference dataset are used to generate an ROI curve, a reference curve, or both.

27. The method of claim 25, wherein non-sequentially scanning includes:
non-sequentially optically scanning frames using a camera at discontinuous locations, and wherein the discontinuous locations are scanned using discontinuous angle positions of an optical scanner within an angular range with angle skipping from 1 to about 100 angle positions,
interlace scanning with multiple scanning passes utilizing a fixed number of skipped data points that is uniform for the multiple scanning passes, or
scanning wavelengths to generate data points in sequential time but having non-sequential wavelength values.

28-39. (canceled)

40. The method of claim 25, further comprising subtracting noise indicated at the reference dataset from ROI dataset, wherein subtracting noise includes:
subtracting periodic noise from the ROI dataset using the reference dataset;
subtracting intermittent noise from the ROI dataset using the reference dataset; or
both.

41-48. (canceled)

49. The method of claim 25, wherein the discontinuous locations are separated by from about 100 RU to about 15,000 RU

50. (canceled)

51. The method of claim 27, wherein non-sequentially scanning includes interlace scanning carried out from about 2 to about 10,000 interlace scanning sweeps to capture all locations within a predetermined dynamic range of locations for reassembling all data points within the predetermined dynamic range.

52. The method of claim 27, wherein the discontinuous locations are generated by scanning individual angle positions:
randomly within the angular range,
with consistently spaced angle positions,
with inconsistently spaced angle positions, or
in a pattern other than that produced by consistently spaced angle position skipping.

53-59. (canceled)

60. The method of claim 25, wherein non-sequentially scanning is carried out using an optical sensing system for use with a scanning system selected from surface plasmon resonance (SPR), surface plasmon resonance imaging (SPRi), plasmon-waveguide resonance (PWR), grating-coupled interferometry (GCI), biolayer interferometry (BLI), waveguide interferometry (WI), or a combination thereof.

61. The method of claim 25, wherein the multiple discontinuous data points captured at discontinuous locations occurs using an optical deflector suitable for angle skipping, wherein the optical deflector includes an acousto-optical deflector (AOD), an acousto-optical modulator (AOM), or an electro-optical deflector (EOD).

62. (canceled)

63. The method of claim 61, comprising adjusting a digital frequency synthesizer to generate the angle skipping.

64. (canceled)

65. A flow cell optical sensing system, comprising:
the optical sensing system of claim 1;
a sensor chip including:
an application surface adapted to receive a plurality of substance spots at multiple regions of interest (ROI) while leaving multiple reference regions devoid of substance spots for referencing, and
an optical interface surface positioned facing a direction opposite the application surface; and
a microfluidic flow cell array including multiple flow cells to deposit multiple substance spots on the application surface.

66-95. (canceled)

96. The method of claim 1, further comprising:
a preliminary step of depositing multiple substance spots on an application surface of a sensor chip to generate multiple regions of interest including the region of interested associated with the substance while leaving at least the reference region without application of the substance spot, wherein the depositing is carried out by a microfluidic flow cell array having multiple flow cells, and wherein the sensor chip also includes an optical interface surface positioned facing a direction opposite the application surface,
wherein the non-sequentially scanning of the substance spots on the application surface is carried out by directing light energy toward the optical interface to generate optically detectable resonances at the regions of interest and optically detectable resonance at the at least one reference region.

97-115. (canceled)
